(19) United States
(12) Patent Application Publication
(10) Pub. No.: US 2025/0286384 A1
(43) Pub. Date: Sep. 11, 2025

(54) SYSTEM AND METHODS FOR INTELLIGENT STABILITY AND CONTROL OF FREQUENCY OF AN INTEGRATED HYBRID RENEWABLE ENERGY SYSTEM

(71) Applicants: KING FAHD UNIVERSITY OF PETROLEUM AND MINERALS, Dhahran (SA); Saudi Data and Artificial Intelligence Authority (SDAIA), Riyadh (SA)

(72) Inventors: Muhammad Majid GULZAR, Dhahran (SA); Muhammad KHALID, Dhahran (SA)

(73) Assignees: KING FAHD UNIVERSITY OF PETROLEUM AND MINERALS, Dhahran (SA); Saudi Data and Artificial Intelligence Authority (SDAIA), Riyadh (SA)

(21) Appl. No.: 18/738,820

(22) Filed: Jun. 10, 2024

Related U.S. Application Data
(60) Provisional application No. 63/562,514, filed on Mar. 7, 2024.

(51) Int. Cl. H02J 3/46; G05B 13/04; H02J 3/38; H02J 3/40

(52) U.S. Cl. CPC H02J 3/46; G05B 13/048; H02J 3/381; H02J 3/40; H02J 2203/20; H02J 2300/24; H02J 2300/28; H02J 2300/40

(57) ABSTRACT

A load frequency controller for the integration of a thermal power generator with renewable energy generators includes first and second power systems situated in separate geographic regions, interconnected through an inter-area tie-line. Each power system incorporates a 3DOF-FOPIDN controller, programmed with a salp swarm algorithm to adjust the controller gain parameters. A model predictive controller (MPC) slaved to the 3DOF-FOPIDN controller generates droop correction values then transmitted to the energy generators. The power deviations from the resources, the tie-line power deviations and a load center power deviation are combined to generate a combined power deviation signal. A frequency generator converts the combined power deviation signal to a frequency deviation value for each area. Feedback loops channel the frequency deviation value to bias factor generator in each area. An ACE signal is generated, which is utilized by the 3DOF-FOPIDN-MPC controller to modulate frequency and maintain grid stability.

### CROSS REFERENCE TO RELATED APPLICATIONS

The present application claims the benefit of priority to U.S. Prov. App. No. 63/562,514, entitled “Intelligent Stability And Control For Frequency Stabilization Of An Integrated Hybrid Renewable Energy System”, filed on Mar. 7, 2024, which is incorporated herein by reference in its entirety.

### STATEMENT OF ACKNOWLEDGEMENT

Support provided by the Interdisciplinary Research Center for Renewable Energy and Power Systems (IRC-REPS), King Fahd University of Petroleum & Minerals, Saudi Arabia under grant no. INRE2320, Saudi Data and AI Authority (SDAIA) and King Fahd University of Petroleum and Minerals at the SDAIA-KFUPM Joint Research Center for Artificial Intelligence under Grant No. JRC-AI-RFP-08, Dhahran, Saudi Arabia is gratefully acknowledged.

### BACKGROUND

### Technical Field

The present disclosure is directed to a system and method for load frequency control (LFC) in multi-area power systems for integrating interconnected power sources with renewable energy sources.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The swift expansion of industries, urban areas, and populations has sparked a heightened need for electrical power. This surge in demand has prompted efforts to boost power generation capacity, with a particular focus on harnessing renewable energy resources (RERs) to effectively meet these energy demands. The RERs, such as solar photovoltaic (PV), wind, hydro, and geothermal systems, have become increasingly used in the global energy mix due to environmental concerns and the rising demand for electricity. Among these, solar and wind energies have been adopted due to their low cost, widespread availability, modularity, and technological advancements that facilitate their integration into the power grid. However, these resources, when implemented in a standalone capacity, impose challenges due to their intermittent nature and geographical dependency. Therefore, various renewable resources can be combined into two or more power generation technologies to enhance overall operational efficiency and optimize capital investments. The combination of the RERs are connected to a power grid.

The power grid, characterized by a complex and extensive network of interlinked power-generating resources, is carefully organized into a series of delineated control areas. Each control area is designed to connect with other regions of various power generation sources through a tie-line to make the system more reliable. The tie-lines facilitate the seamless transfer of electricity, especially from regions with surplus energy, often due to the variable output of RERs, to those experiencing a deficit. The incorporation of RERs into the grid introduces potential instability, particularly when the area frequency significantly drops or when load fluctuations lead to changes in power flow across the lines, sometimes even surpassing predefined limits, thereby impacting system stability.

Frequency regulation is a factor that ensures the safe and stable operation of the power system following load changes or transient events in RERs. By minimizing the real power imbalance between supply and demand, the system's durability is safeguarded. The governor of the power plant adjusts the operating point to align actual power output with consumption, mitigating potential issues. In scenarios of heightened demand, the capabilities of the governor may be stretched thin, necessitating auxiliary measures for maintaining system stability. Therefore, the development of a load frequency controller is required to address these challenges.

The conventional technologies implemented in load frequency control (LFC) include ranging from self-tuning controllers to adaptive, robust, and sliding mode controllers, including those based on fuzzy logic, adaptive neuro-fuzzy inference system (ANFIS), model predictive control (MPC), and adaptive MPC. A significant focus has been placed on the implementation of sliding mode controllers due to the simplicity they offer in design, application, functionality, and cost-effectiveness. Control techniques, such as optimal Gaussian quadratic linear and regulator quadratic linear are known for maintaining frequency within safe limits, attributed to their straightforward setup and application.

The proportional-integral-derivative (PID) controller, despite its complex tuning process, remains widely used for controlling significant industrial processes. However, to achieve desired system outputs, researchers have explored hybrid approaches that combine PID controllers with linear secondary controllers. The conventional PID technology and its variants offer several advantages, but they can be affected by nonlinearities, variable load conditions, and operational changes.

Implementing controllers based on fuzzy logic or artificial neural networks (ANNs) presents challenges due to computational demands and assumptions. To address disturbances and maintain stable power system frequencies, controllers with enhanced degrees of freedom (DOF) have been developed. These DOF controllers use separate loops for more reliable and efficient control. Higher DOF can help dampen system oscillations and improve set-point tracking.

Recent literature highlights the use of three degrees of freedom fractional order proportional-integral-derivative (3DOF-FOPID) controllers for supervising power system frequencies, both with and without RERs. The fractional order flexibility in control design adds an interesting dimension to achieving optimal performance. Furthermore, cascaded designs of FOPI-FOPIDN controllers and fractional MPC have been developed to mitigate frequency oscillations due to load variability and system uncertainties. These designs utilize optimization algorithms such as the sine-cosine algorithm (SSA) and the sooty terns optimization algorithm (STOA) to fine-tune controller gains. The integration of MPC with PIDN controllers and the application of gain scheduling and master-slave (MS) architectures, where FOPIDN controlled by SSA serves as the master and MPC as the slave, have been in use to create compact controllers that effectively counter frequency oscillations.

CN112636368B discloses an automatic power generation control for multi-source, multi-area interconnected systems, with a focus on a fractional order PID controller utilizing a celestial beard algorithm. However, the implementation of the automatic power generation control is complex.

IN202211042704A details a two-area MPC-based system aimed at mitigating voltage and frequency deviations, employing a Wild Horse Optimizer for tuning. This is accomplished by combining an automatic voltage regulator (AVR) and load frequency control (LFC) system for the power system. Further, implementing a centralized model predictive controller (MPC) scheme using the MPC designer tool and specify sampling time, prediction horizon, control horizon, measured outputs (MOs), and manipulated variables (MVs). The Wild Horse Optimizer (WHO) is used to generate the optimal tuning of specified weights of the model predictive controller. The two-area MPC-based system is complex to implement and requires a large amount of tuning.

A publication describing a CPSOGSA optimization algorithm-driven cascaded 3DOF-FOPID-FOPI controller for LFC and an optimized MPC by PSO for frequency control in microgrids also provides insight into various control strategies. (See: Xie et al. “CPSOGSA optimization algorithm-driven cascaded 3DOF-FOPID-FOPI controller for load frequency control of DFIG-containing interconnected power system”, published in Energies 2023, Vol. 16, page 34 on Jan. 28, 2023).

Each of the aforementioned references suffers from one or more drawbacks hindering their adoption. The aforementioned conventional techniques fail to minimize frequency deviations in tie-line power flow between multiple geographic areas, and cannot provide a stable and efficient power system conducive to the integration of RERs and thermal generators. Accordingly, it is one object of the present disclosure to provide methods and systems for a load frequency control system and method that addresses the aforementioned challenges and contributes a solution to the field of power system control when integrating interconnected power sources with renewable energy sources.

### SUMMARY

In an exemplary embodiment, a load frequency control system for integrating interconnected power sources with renewable energy sources is described. A load frequency control system for integrating interconnected power sources with renewable energy sources, comprising: a first power system located in a first geographic region and a second power system located in a second geographic region, wherein the first power system and the second power system are connected by an inter-area tie-line, wherein each power system includes: a three degrees of freedom fractional order proportional integral derivative (3DOF-FOPIDN) controller, wherein the 3DOF-FOPIDN controller includes electrical circuitry, a memory having program instructions including a salp swarm algorithm stored therein and at least one processor configured to execute the salp swarm algorithm to update a set of gain parameters of the 3DOF-FOPIDN controller, a model predictive controller (MPC) operatively connected to the 3DOF-FOPIDN controller, a droop control unit connected to the MPC, a plurality of renewable energy resources connected to the droop control unit, a first adder connected to the plurality of renewable energy resources, wherein the first adder is configured to receive a power deviation signal from each of the plurality of renewable energy resources, add the power deviation signal and generate a total power deviation signal, a load center configured to generate a load power perturbation signal, a subtractor operatively connected to receive the total power deviation signal, the load power perturbation signal, and an inter-area tie line power deviation signal ΔPₜᵢₑ, wherein the subtractor is configured to subtract the load power perturbation signal and the inter-area tie-line power deviation signal from the total power deviation signal, and generate a power deviation difference signal, a frequency generator connected to the subtractor, wherein the frequency generator is configured to receive the power deviation difference signal and output a frequency deviation value, a feedback loop configured to transmit the frequency deviation value to a bias factor generator, wherein the bias factor generator is configured to generate a bias factor based on the frequency deviation value, and a second adder configured to receive the bias factor and the inter-area tie line power deviation signal and generate an area control error (ACE) signal, wherein the 3DOF-FOPIDN controller is configured to receive the ACE signal from the second adder, update a set of gain parameters, generate frequency error correction signals and transmit the frequency error correction signals to the MPC, wherein the MPC is configured to generate droop error correction signals based on the frequency error correction signals and transmit the droop error correction signals to the droop control unit.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates a block diagram of a multi area hybrid power model architecture, according to certain embodiments.

FIG. 2 presents a method flow of a salp swarm algorithm (SSA) process as applied within a load frequency control (LFC) system, according to certain embodiments.

FIG. 3 illustrates a schematic representation of a 2DOF-FOPIDN with slaved MPC control strategy within the system, according to certain embodiments.

FIG. 4 illustrates the frequency response versus time in seconds for a 1% load change in area-1 in a comparison of the 3DOF-FOPIDN-MPC controller with conventional controllers, according to certain embodiments.

FIG. 5 illustrates the frequency response versus time in seconds for a 1% load change in area-2 in a comparison of the 3DOF-FOPIDN-MPC controller with conventional controllers, according to certain embodiments.

FIG. 6 illustrates a comparison of the tie-line power exchange versus time in seconds for a 1% load change of the 3DOF-FOPIDN-MPC controller with conventional controllers, according to certain embodiments.

FIG. 7 illustrates the frequency response versus time in seconds for a 3% load change in area-1 in a comparison of the 3DOF-FOPIDN-MPC controller with conventional controllers, according to certain embodiments.

FIG. 8 illustrates the frequency response versus time in seconds for a 3% load change in area-2 in a comparison of the 3DOF-FOPIDN-MPC controller with conventional controllers, according to certain embodiments.

FIG. 9 illustrates a tie-line power exchange versus time in seconds for a 3% load change, according to certain embodiments.

FIG. 10 illustrates a bubble chart depicting the integral of time-weighted absolute error (ITAE) performance indices for various controllers following a step load change in a comparison of the 3DOF-FOPIDN-MPC controller with conventional controllers, according to certain embodiments.

FIG. 11A provides a comprehensive evaluation of the controller performance under variable load conditions versus time in seconds, according to certain embodiments.

FIG. 11B provides a comprehensive evaluation of the controller performance under for frequency deviations versus time in area-1 in a comparison of the 3DOF-FOPIDN-MPC controller with conventional controllers, according to certain embodiments.

FIG. 11C provides a comprehensive evaluation of the controller performance under for frequency deviations versus time in area-2 in a comparison of the 3DOF-FOPIDN-MPC controller with conventional controllers, according to certain embodiments.

FIG. 11D provides a comprehensive evaluation of tie-line deviation versus time in a comparison of the 3DOF-FOPIDN-MPC controller with conventional controllers, according to certain embodiments.

FIG. 12 is a bubble chart presenting a comparative performance analysis of the 3DOF-FOPIDN-MPC controller with conventional controllers using the ITAE performance index, according to certain embodiments.

FIG. 13A illustrates the change in load power versus time in seconds under random load variations within the power system, according to certain embodiments.

FIG. 13B illustrates the frequency response versus time in seconds under random load variations in area-1 in a comparison of the 3DOF-FOPIDN-MPC controller with conventional controllers, according to certain embodiments.

FIG. 13C illustrates the frequency response versus time in seconds under random load variations in area-2 in a comparison of the 3DOF-FOPIDN-MPC controller with conventional controllers, according to certain embodiments.

FIG. 13D illustrates a tie-line power exchange response versus time in seconds under random load variations within the power system, in a comparison of the 3DOF-FOPIDN-MPC controller with conventional controllers, according to certain embodiments.

FIG. 14 illustrates a bubble chart depicting the integral of time-weighted absolute error (ITAE) performance indices under random load variations within the power system in a comparison of the 3DOF-FOPIDN-MPC controller with conventional controllers, according to certain embodiments.

FIG. 15 illustrates a sensitivity analysis of the controller for area 1, according to certain embodiments.

FIG. 16 illustrates the sensitivity analysis of the controller for area 2, according to certain embodiments.

FIG. 17 illustrates the response of photovoltaic (PV) power generation versus time, according to certain embodiments.

FIG. 18 illustrates the response of wind power generation versus time, according to certain embodiments.

FIG. 19 is an illustration of a non-limiting example of details of computing hardware used in the computing system, according to certain embodiments.

FIG. 20 is an exemplary schematic diagram of a data processing system used within the computing system, according to certain embodiments.

FIG. 21 is an exemplary schematic diagram of a processor used with the computing system, according to certain embodiments.

FIG. 22 is an illustration of a non-limiting example of distributed components that may share processing with the controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of the present disclosure are directed to a load frequency control system, a method controlling load frequency deviations and a hybrid controller designed to harmonize interconnected power sources with renewable energy sources across multiple geographic areas. The system leverages a three degrees of freedom fractional order proportional integral derivative (3DOF-FOPID) controller in tandem with a model predictive controller (MPC) within each geographic area, which are both integrated with renewable energy resources (RERs) and a thermal generator to correct power deviation.

The present disclosure is characterized by its ability to manage changes in load power through specific load centers for each geographic area, alongside adjustments for tie-line power deviations. These processes yield system power deviations that are managed by frequency generators, resulting in the production of frequency deviation values. Furthermore, the system includes feedback loops that apply frequency bias factors to enhance the input to the 3DOF-FOPID-MPC controllers, leading to the generation of an area control error (ACE) for each area.

The ACE is utilized by the 3DOF-FOPIDN controllers in conjunction with a salp swarm algorithm to modify controller gain parameters and to generate frequency error correction signals. These signals are subsequently processed by the MPC, which generates droop error correction signals. These signals are distributed to the RERs and thermal generator within each geographic area.

The system is implemented to minimize frequency deviations in the tie-line power flow between the geographic areas. This is accomplished by summing at the inputs of the 3DOF-FOPIDN controllers with a respective frequency deviation value multiplied by a respective bias factor to generate the respective ACE for the area. Each 3DOF-FOPIDN controller receives the ACE, adjusts a set of controller gain parameters based on a salp swarm optimization, generates frequency error correction signals, and transmits these signals to the MPC. The MPC then receives these signals, generates droop error correction signals and transmits these signals to a plurality of RERs and a thermal generator in each geographic area. Through this comprehensive approach, the system and methods of the present disclosure facilitate the integration of renewable energy sources into existing power grids, enhancing the stability and efficiency of power distribution while maintaining grid stability and reliability.

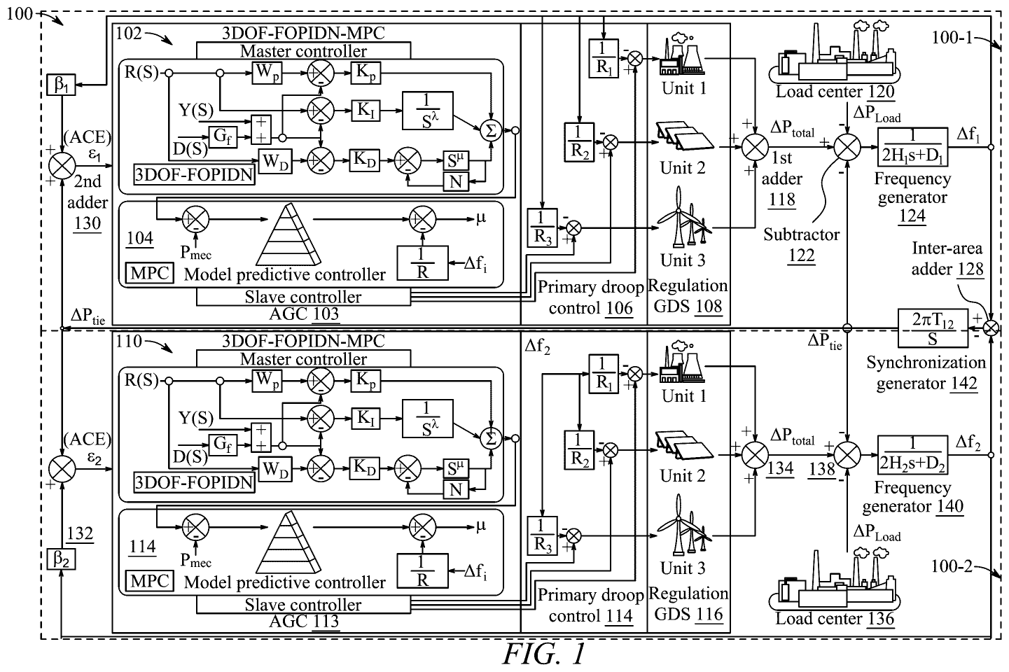

FIG. 1 illustrates a block diagram of a multi area hybrid power system architecture. The multi area hybrid power system architecture implements a load frequency control (LFC) system 100, alternatively referred to as a system 100. The system 100 is integrated into a grid-connected multi-area power system. The hybrid system is an illustration of a power management system designed to integrate various combinations of energy resources, include renewable energy resources and traditional energy resources, to manage the effective distribution of power and stabilization of frequency across various geographic zones. As depicted in FIG. 1, the system 100 is implemented for a first power system 100-1 located in a first geographic region and region and a second power system 100-2 located in a second geographic region. A power system is a network of electrical components deployed to supply, transfer, and use electric power. An example of a power system is the grid that provides power to homes and industry within a respective geographical region. Geographical locations refer to the specific geographic areas or regions where the power systems are installed. The geographical locations can range from small communities to entire countries and are defined by their physical boundaries. The first geographic region and the second geographic region indicate two distinct areas where separate power systems are installed, to serve the energy demands of the respective area. The first geographic region and the second geographic region may be geographically and/or communicatively mutually exclusive.

The first and second power systems (100-1, 100-2) are each configured to integrate at least one energy source including wind energy, solar energy, and thermal energy by implementing a thermal unit 1, a photovoltaic unit 2, a wind power unit 3. The first power system 100-1 delivers the power output to a first load center 120, and the second power system 100-2 delivers the power output to a second load center 136. In one aspect, the first power system 100-1 and the second power system 100-2 are connected by an inter-area tie-line. A tie-line in power systems is a transmission line that connects two different power grids or systems. This connection helps to exchange power between the systems for balancing supply and demand across wider areas.

Each power system (100-1, 100-2) includes an automatic generation control (AGC), which is a system used within electric power grids to maintain the balance between the electricity supply and demand. The first power system 100-2 includes the AGC 103, and the second power system 100-2 includes the AGC 112. The AGC (103, 112) adjusts the power output of multiple generators at different power plants in response to changes in the load. The AGC (103, 112) may be a programmable component integrated with a controller unit of each power supply (100-1, 100-2).

The controller unit is formed by a three degrees of freedom fractional order proportional integral derivative (3DOF-FOPID) master controller 102 and a slaved model predictive controller (MPC) 104.

3DOF-FOPIDN controller 102 includes an electrical circuitry, a memory having program instructions including a salp swarm algorithm stored therein and at least one processor configured to execute the salp swarm algorithm to update a set of gain parameters of the 3DOF-FOPIDN controller.

The salp swarm algorithm (SSA) is a computational algorithm inspired by the swarming behavior of salps in the ocean. Salps move in a swarm in a chain-like formation, a behavior which is translated into an algorithmic context to solve optimization problems. In the present disclosure, the SSA is implemented to optimize the parameters of the 3DOF-FOPIDN controller 102 for adjusting power distribution across the power grid. For example, if the frequency of the power grid starts to fall because demand is outstripping supply, the AGC 103 would detect this and could send signals to increase the output of certain generators. Conversely, if the frequency rises above the nominal value due to an excess of supply over demand, the AGC 103 system instructs some generators to scale back their output. The 3DOF-FOPIDN controller 102 and the 3DOF-FOPIDN controller 110 are used to fine-tune these adjustments by predicting future system states and adjusting control inputs accordingly to ensure smooth, stable operation without oscillations or overshoots.

The 3DOF-FOPIDN controller is configured based on the traditional proportional, integral, and derivative (PID) controller model. The PID controller is modified with the addition of fractional calculus, which helps to achieve nuanced adjustments to the response of the controller, providing greater flexibility and accuracy in managing the dynamic conditions of the power grid, especially when integrating renewable energy sources with their inherent variability.

The MPC 104 is operatively slaved to the 3DOF-FOPIDN controller and configured for adding a predictive strategy to the system's control strategy. Utilizing a mathematical model of the power system, the MPC 104 forecasts future system behaviors and calculates optimal control actions to mitigate potential disturbances. The MPC 104 is capable of accommodating multi-variable constraints and anticipating future events, thereby managing dynamic and complex characteristics of the power systems. For example, the MPC 104 is capable of predicting the variability in power generation from a photovoltaic unit due to cloud coverage and pre-emptively adjusting the power output from other units to compensate.

Each power system (100-1, 100-2) further includes droop controls. The first power system 100-1 includes a primary droop control 106, and the second power system 100-2 includes a secondary droop control 114. These droop controls are configured to dynamically adjust power outputs from the generation units in response to real-time changes in load demand, exemplifying the system's responsive defense against sudden fluctuations in power consumption. For instance, when a large industrial complex significantly increases its energy usage without warning, the droop control mechanism immediately responds, instructing the connected generators to ramp up production, thus stabilizing the potential disruption in frequency.

The system 100 further includes a plurality of renewable energy resources connected to the droop control unit (106, 114). The plurality of renewable energy resources includes thermal, wind, and photovoltaic energy resources, as depicted in FIG. 1. In a typical scenario, the system 100 takes command of the power grid of each geographic area and continuously assesses power output from various interconnected energy units, adapting the output in real-time to match the grid's fluctuating demand. The droop control unit (106, 114) of each power system (100-1, 100-2) is particularly configured to receive the frequency deviation value from the feedback loop, generate negative droop values for each of the renewable energy sources, add the droop error correction signals from the respective MPC controller to the negative droop values of each of the renewable energy sources, generate corrected droop values and transmit the corrected droop values to the renewable energy sources. The corrected droop values are configured to minimize frequency imbalances due to load disturbances in the power generation of the plurality of renewable energy sources of each power system.

In an implementation of the system 100, regulation generation dispatch stations (GDS), are configured for the management of power distribution. The first power system 100-1 includes a first GDS 108, and the second power system 100-2 includes a second GDS 116. The GDS stations act as the conductors of the power generation distribution, carefully allocating and distributing electricity from a suite of sources that range from traditional thermal power plants to modern renewable energy farms. The GDS (108, 116) analyses consumption patterns, such as the increased energy demand during peak business hours, to calibrate power dispatch with pinpoint accuracy, fulfilling the demand without excess.

Each power system (100-1, 100-2), includes a first adder. The first power system 100-1 includes a first adder 118, and the second power system 100-2 includes a first adder 134. The first adder (118, 134) is connected to the plurality of renewable energy resources. The first adder (118, 134) is configured to receive a power deviation signal from each of the plurality of renewable energy resources, add the power deviation signals and generate a total power deviation signal.

In another aspect, the first power system 100-1 includes a load center 120, and the second power system 100-2 includes a load center 136. The load center (120, 136) generates a load power perturbation signal. The load centers (120, 136) serve as the collection points for consumption data across the power network, from residential neighbourhoods to industrial zones, painting a detailed picture of the energy landscape. The load centers (120, 136) are configured to gauge the energy requirements of the grid, for example, how a smart meter reads household consumption, enabling the system to adeptly channel the generated power where it is most required.

According to one aspect, the first power system 100-1 includes a subtractor 122, and the second power system 100-2 includes a subtractor 138. The subtractor (122, 138) is operatively connected to receive the total power deviation signal, the load power perturbation signal and an inter-area tie line power deviation signal ΔPₜᵢₑ, and is configured to subtract the load power perturbation signal and the inter-area tie-line power deviation signal ΔPₜᵢₑ from the total power deviation signal and generate a power deviation difference signal.

By performing the subtraction, the subtractor (122, 138) generates a power deviation difference signal. The power deviation difference signal effectively isolates the component of power deviation that is attributable to factors within the control frequency regulation mechanisms of the system, excluding the effects of load changes and inter-area power exchanges.

The first power system 100-1 includes a frequency generator 124, and the second power system 100-2 includes a frequency generator 140. The frequency generator (124, 140) is connected to the subtractor (122, 138), respectively. The frequency generators (124, 140) are configured receive the power deviation difference signal and output a frequency deviation value. The frequency generators (124, 140) can compute deviations from the target frequency by interpreting area control error (ACE) signals. ACE is a quantity used in operating bulk electric systems. ACE is defined as the instantaneous difference between a balancing authority's net actual and scheduled interchange with all adjacent interconnected balancing authority areas. The ACE is measured in megawatts (MW). The ACE signals, resultant from the aggregation of power deviations, offer a metric of discrepancy from the predetermined frequency set-point. One function of the frequency generators (124, 140) is to provide precise feedback necessary for the microcontrollers to effectuate corrective measures.

In one aspect, the system 100 includes an inter-area adder 128 connected to the frequency generators (124, 140) of the power systems (100-1, 100-2). The inter-area adder 128 is configured to add the frequency deviation value of the first power system to the frequency deviation value of the second power system and generate a negative sum of the frequency deviation values.

The system 100 also includes a synchronization generator 142 connected to the inter-area adder 128 configured for aligning the phase and frequency of electricity produced from the disparate sources. This alignment ensures that when the power from various generators is combined, the resulting electricity is coherent, which maintains the integrity of the power supplied to the grid. The synchronization generator 142 is particularly configured to receive the negative sum of the frequency deviation values and generate the inter-area tie line power deviation signal.

In one aspect, a feedback loop is configured to transmit the frequency deviation value of each area to a bias factor generator (β₁, β₂), where the bias factor generator is configured to generate a bias factor based on the frequency deviation value. The feedback loop is configured to transmit the actual frequency of the electricity being generated which is compared with a predefined nominal frequency value. The difference between these two values is referred to as the frequency deviation.

Once the frequency deviation is identified, the feedback loop transmits this value to a bias factor generator. The bias factor generator produces a compensating bias factor, which is a corrective signal derived from the frequency deviation value. The generation of the bias factor is a response to the deviation which adjusts the control inputs to the power generation system.

The bias factor is effectively a calculated adjustment that, when applied to the system, helps to correct the frequency back towards its nominal value, thereby ensuring the consistent delivery of power at the correct frequency. This correction is vital for the seamless operation of the grid and the prevention of power outages or damage to electrical equipment, which can be sensitive to frequency variations. The feedback loop, by continuously monitoring and adjusting the frequency, plays a pivotal role in the real-time regulation of the power system.

Each power system (100-1, 100-2), in one aspect, includes a second adder. The first power system 100-1 includes a second adder 130, and the second power system 100-2 includes a second adder 132. The second adder (130, 132) configured to receive the bias factor and the inter-area tie line power deviation signal ΔPₜᵢₑ and generate the ACE signal.

The 3DOF-FOPIDN (102, 110) controller is configured to receive the ACE signal from the second adder (130, 132), update the set of gain parameters based on the execution of the salp swarm algorithm, generate frequency error correction signals and transmit the frequency error correction signals to the MPC (104, 112). The MPC (104, 112) is configured to generate droop error correction signals based on the frequency error correction signals and transmit the droop error correction signals to the droop control unit (106, 114).

The micro-grid, depicted in FIG. 1, also accounts for nonlinearities, making the system 100 more functional. Most of these nonlinearities are composed of a rate limiter and a generator rate constraint (GRC) which is around 12%. Each energy unit can be modelled by deriving the designing parameters, and nonlinearities can be computed using the designing parameters. Modelling of each energy unit is described in subsequent description.

The thermal unit includes components, such as an electrical generator, a governor, a steam turbine, and a reheater. The governor attached to the generator is configured for maintaining frequency stability during load imbalances. In an aspect, to model the thermal system's units, a formula given in equation (1) can be calculated by considering a combined power plant capacity of 2200 MW for each area, with a standard operational load of 2000 MW and one plant running at 1000 MW. The base power level is set at 1000 MVA. The formula also includes various nonlinear elements to reflect a more realistic system behavior, among which are a rate limiter and a generator rate constraint (GRC), restricting the change in power output to 10% per minute (equivalent to 0.0017 p.u. MW/s) for both increasing and decreasing rates. The ΔP_{gi}(s) that represents the governor output is given by eq. (1).

$$Δ {P}_{g i} ( s ) = Δ {P}_{r e f} ( s ) - \frac{1}{R} Δ {f}_{i} ( s ) \qquad ( 1 )$$

The ΔP_{ref} and Δfᵢ are the reference power and change in frequency respectively, while droop for the thermal generator is represented by 1/R. The governor (GDB with 0.5% backlash), turbine and re-heater is mathematically represented by a transfer function indicated by the eq. (2)-(5).

$${G}_{g o v} ( s ) = \frac{0.8 - ( \frac{0.2}{π} ) s}{1 + s {T}_{g}} \qquad ( 2 )$$

$$1 / {G}_{t} ( s ) = \frac{{K}_{t}}{1 + s {T}_{g}} \qquad ( 3 )$$

$${G}_{r} ( s ) = \frac{1 + s {K}_{r} {T}_{r}}{1 + s {T}_{r}} \qquad ( 4 )$$

$$Δ {f}_{i} ( s ) = {G}_{p} ( s ) [ {\sum }_{j = 1}^{n} Δ {P}_{R i j} - Δ {P}_{d , i} - Δ {P}_{tie , i} ] \qquad ( 5 )$$

where Gₚ(s)=1/Mᵢs+Dᵢ, therefore the thermal generator output power will always adjust to meet the power demand.

In wind energy units, such as wind turbine generators, the force of the wind acts upon the propeller blades of a windmill, causing rotation aligned with the wind direction. The intermittent nature of wind turbines, similar to solar power installations, is due to the variability of wind speed across different locations and the unpredictable nature of weather conditions.

The wind power output equation that drives the wind generator is given by eq. (6).

$${P}_{w} = \frac{1}{2} ρ {a}^{2} {V}_{w}^{3} {C}_{p} ( TSR , {β}_{w} ) \qquad ( 6 )$$

Equation (7) and equation (8) are defined as follows: the air density (Kg/m³); Cₚ represents the power coefficient; β_{w} (degrees) represents the blade pitch angle; a(m²) represents the swept area; TSR is the turn speed ratio; and Vₘ (msec) is the wind speed.

$${C}_{p} = 0 \text{.5} ( TSR - 0.222 {β}^{2} - 5.6 ) {e}^{- 0 \text{.17} TSR} \qquad ( 7 )$$

$$TSR = \frac{rpm \times π D}{60 V} \qquad ( 8 )$$

where D[m] and rpm (revolutions per minute] represent the blade rotor diameter and rotor speed, respectively. The wind farm may be comprised of a number of wind turbines with a capacity of 500 MW in each area. Equations (9)-(12) describe the architecture of the wind farm system containing transfer function pitch control, pitch actuator, and wind generator.

$${G}_{P} ( s ) = \frac{{K}_{P 1} ( 1 + {sT}_{P 1} )}{( 1 + s )} \qquad ( 9 )$$

$${G}_{H} ( s ) = \frac{{K}_{P 2}}{( 1 + {sT}_{P 2} )} \qquad ( 10 )$$

$${G}_{D} ( s ) = \frac{{K}_{P 3}}{( 1 + {sT}_{P 3} )} \qquad ( 11 )$$

$${G}_{I} ( s ) = \frac{1}{( 1 + {sT}_{w} )} \qquad ( 12 )$$

The output of photovoltaic (PV) panels is directly influenced by variations in solar irradiance and ambient temperature. In this context, maximum power point tracking (MPPT) is essential. It optimizes the operation of a boost converter to ensure consistent tracking of the maximum power output. Concurrently, the inverter is tasked with supplying the grid with alternating current (AC) at the necessary voltage and frequency levels. The analysis considers the equivalent circuit of a PV cell with a singular diode, which provides a balance of simplicity and precision in modelling PV cells.

The system can be mathematically represented as:

$${I}_{PV} = {I}_{PH} - {I}_{D} \frac{{V}_{PV} - {I}_{PV} {R}_{S}}{{R}_{SH}} \qquad ( 13 )$$

$${I}_{D} = {I}_{o} ( {e}^{\frac{q ( {V}_{PV} - {I}_{PV} {R}_{S} )}{{R}_{SH}}} - 1 ) \qquad ( 14 )$$

$${I}_{PH} = \frac{{ψ}_{PH}}{1000} ( {I}_{SH} + {k}_{1} ( T - 25 ) ) \qquad ( 15 )$$

where V_{PV} and I_{PV} are the voltage and current generated by the PV system and the photo current, I_{PH}, is represented by the Iₒ reverse bias current. Diode current (I_{D}); short-circuit current (I_{SC}); q is the charge of an electron, k is the Boltzmann constant, T is the ambient temperature in Kelvin; k₁ is the short-circuit current temperature coefficient, and ψ_{PH} is the sun irradiation; R_{SH} and R_{S} stand for the parallel and series resistances, respectively.

The transfer function, G_{PV}(s) is mathematically represented by:

$${G}_{PV} ( s ) = \frac{a + bs}{{s}^{2} + cs + d} \qquad ( 16 )$$

Where ‘a’ is the negative value less than zero in the transfer function, ‘c’ and ‘d’ are the negative poles, and ‘b’ is the PV system gain.

The designing parameters of the power model are expressed in Table 1.

TABLE 1
Nominal power system designing parameters.

| Parameters | Values | |
|---|---|---|
| Turbine time constant (Tₜ) | 0.3 | s |
| Governor time constant (T_{g}) | 0.08 | s |
| Droop characteristics (R) | 2.5 | Hz/pu MW |
| Frequency bias factor (β) | 0.4312 | MW/Hz |

| | |
|---|---|
| Damping constant (D) | 0.015 |
| Inertia constant (H) | 0.083 |

Wind Turbine Generator Parameters

| | | |
|---|---|---|
| Gain pitch controller K_{P1} | 1.25 | pu MW |
| Pitch time constant T_{P1} | 0.6 | s |
| Hydraulic gain pitch actuator K_{P2} | 1 | pu |
| Hydraulic time pitch actuator T_{P2} | 0.041 | s |
| Data fit pitch gain constant K_{P3} | 1.4 | pu MW |
| Data fit pitch time constant T_{P3} | 1 | s |
| wind generator time constant T_{w} | 4 | s |

PV System Parameters

| | |
|---|---|
| a, b, c, d | 900, −18, 100, 50 |

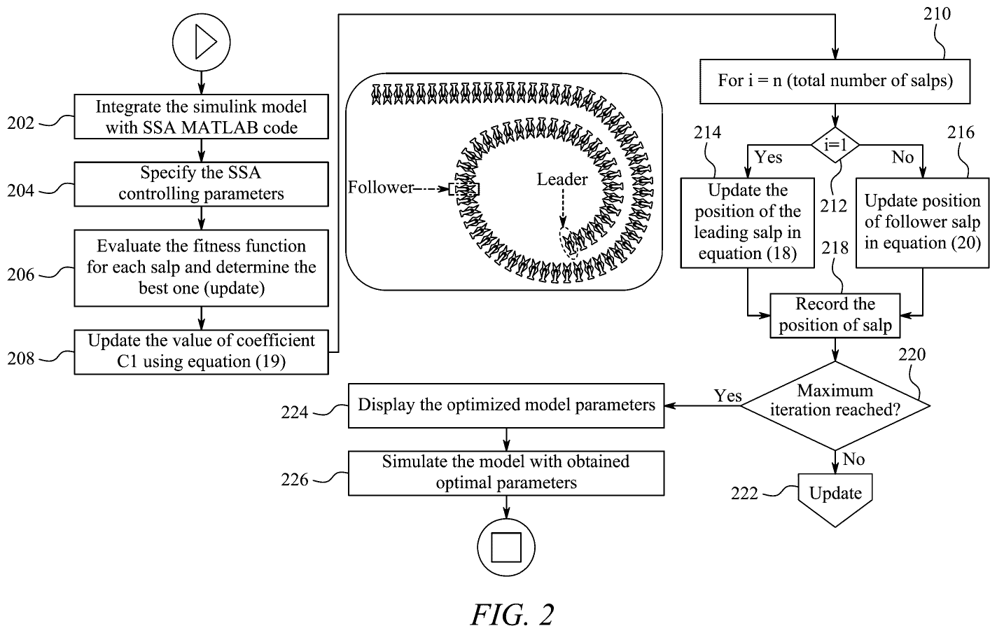

FIG. 2 presents a method flow of the salp swarm algorithm (SSA) process as applied within a LPC system, in accordance with an aspect of the present disclosure. The algorithm begins at step 202, integrating the Simulink model with SSA MATLAB code, an initial necessary step to create a base for subsequent optimization. A cost function, J, shown in equation (17), is entered in step 202. At step 204, the SSA controlling parameters are specified, setting the algorithmic conditions under which the SSA will operate.

At step 206, the system evaluates the fitness function for each salp and identifies the most optimized solution in the present iteration. Step 206 involves the computation of the integral time absolute error (ITAE) performance index, which aims to minimize the absolute frequency deviations (Δf₁, Δf₂) and the tie-line power deviations (ΔPₜᵢₑ) over time, essential for enhancing active response of the system.

At step 208, the value of the coefficient ‘C1’ is updated using equation (19), shown below, potentially improving the search for optimal control parameters in the next iteration. In step 210, a value of i may be determined. In step 212, it may be determined whether the value of i is 1. The process continues by following two pathways: for the leading salp, the position is updated via equation (18) as shown in step 214, when the value of i is 1; for the following salps, their positions are updated as per equation (20) shown in step 216 when the value of i is not 1.

The algorithm records the position of each salp in step 218, an essential task for tracking the evolution of the search space exploration. The information is utilized for analysing the convergence behaviour of the SSA.

A decision-making step occurs at step 220, where the algorithm checks if the maximum number of iterations has been reached. If not, at step 222 the process loops back to step 212, continuously refining the search for the optimal set of parameters. Conversely, if the maximum iteration criterion is met, the process proceeds to step 224, where the optimized model parameters are displayed. These parameters are then used to simulate the model with the obtained optimal parameters at step 226, which concludes the SSA optimization sequence.

In the field of LFC, the integral time absolute error (ITAE) is often utilized for optimization because it offers a quick settling time and serves as an effective metric for system response. The cost function J is an integral time absolute error given by:

$$J = ITAE = {\int }_{0}^{∞} t ( \vert Δ {f}_{1} \vert + \vert Δ {f}_{2} \vert + \vert Δ {P}_{tie} \vert ) dt \qquad ( 17 )$$

where t is time, Δf₁ is the frequency deviation value of the first power system and Δf₂ is the frequency deviation value of the second power system.

To improve the active response of the system, the J value must be decreased when the ITAE involves the three reactions f₁, f₂, and Pₜᵢₑ. The parameters of (3DOF-FOPIDN) controller is optimized within the range [0, 15], these parameters include Kₚ, Kᵢ, K_{D}, μ and λ. While the limits of the filter factor “N” of the FOPIDN controller is restricted in range [1, 300].

The SSA is an optimization method inspired by the natural foraging behaviour of salps, which form chain-like structures. The SSA is classified into two segments, the leaders who guide the group and the followers.

The SSA leader movement is decided by equation (18)

$${K}_{j}^{i} = \{ \begin{matrix}{M}_{i} + {C}_{1} ( ( {ub}_{j} - {lb}_{j} ) {C}_{2} + {lb}_{j} ) , & {C}_{3} \geq 0 \\ {M}_{i} - {C}_{1} ( ( {ub}_{j} - {lb}_{j} ) {C}_{2} + {lb}_{j} ) , & {C}_{3} < 0\end{matrix} \qquad ( 18 )$$

Upper and lower bounds of the jₜₕ dimension are denoted by ubⱼ and lbⱼ, where M and K represent the desired meal and the position of the salp in two dimensions, respectively. C₁ is further expressed as in a form similar to that used for the C₂ and C₃ uniform coefficients (19)

$${C}_{1} = 2 {e}^{- {( \frac{4 t}{{t}_{max}} )}^{2}} \qquad ( 19 )$$

where t indicates the present iteration and tₘₐₓ means the maximum number of iterations. The position is updated as given by eq. (20):

$${K}_{j}^{i} = \frac{1}{2} {at}^{2} + {v}_{0} t \qquad ( 20 )$$

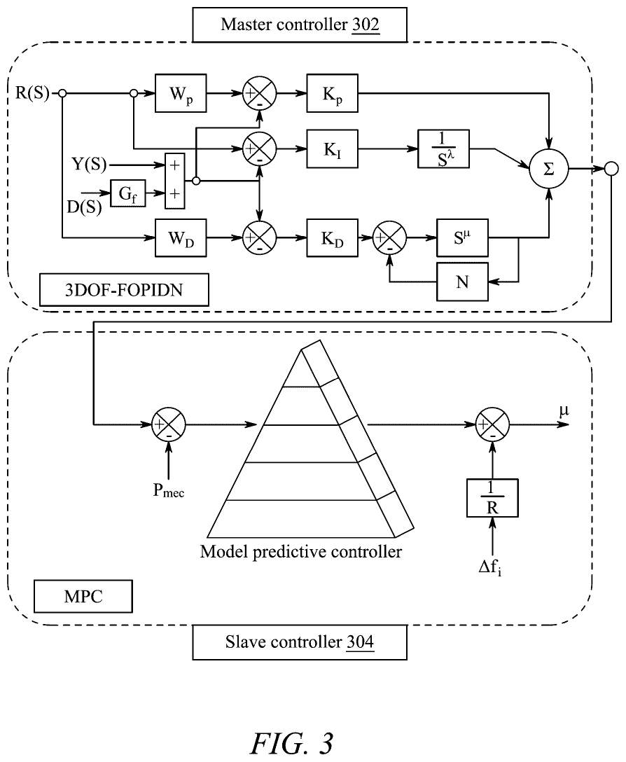

FIG. 3 illustrates a schematic representation of the 3DOF-FOPIDN-MPC controller within the system. The schematic presents the synergistic operation of a master controller 302 and a slave controller 304. The 3DOF-FOPIDN controller 302 of each power system is a master controller configured to execute the salp swarm algorithm to minimize a cost function J to update the set of gain parameters of the 3DOF-FOPIDN controller. The 3DOF-FOPIDN controller of each power system (100-1, 100-2) incorporates proportional (Kp), integral (Ki), and derivative (Kd) elements enhanced with fractional calculus denoted by the exponents λ and μ, respectively, for a broader dynamic response and superior handling of nonlinearities within the feedback loop of the system. Each of the gain parameters are within a range of 0 to 15.

The master controller 302 processes the error signal R(s), representing the deviation from the desired set-point, and the system output Y(s), signifying the current state of the system. Additionally, it factors in disturbances D(s) which may affect system performance. The fractional-order calculus provides flexibility, that helps the controller to adjust its response to the error and disturbances more precisely than traditional integer-order PID controllers.

The slave controller 304 is the MPC that operates with the master controller. The MPC 304 uses a predictive model of the system to optimize the control actions based on the anticipated future states of the system. The MPC 304 takes output of the master controller and computes the optimal control signal P_{mec} to mitigate frequency fluctuations effectively. Such hierarchical control scheme provides responsive adjustments to the system, ensuring robust performance in the face of varying conditions and uncertainties.

The 3DOF-FOPIDN controller is configured to optimize its parameters within a specified range, enhancing stability and responsiveness of the system. The parameters include the proportional gain (Kp), integral gain (Ki), and derivative gain (Kd), along with the fractional orders λ and μ, and the filter coefficient N. The set of gain parameters of each power system further include a first control vector u and a second control vector λ, wherein 0≤μ≤1 and 0≤λ≤1, and a filter coefficient N of the FOPIDN controller is within a range of 1 to 300. These parameters are finely tuned to match the dynamic characteristics of the system, thus tailoring the response of the controller to the specific requirements of the system 100.

The 3DOF-FOPIDN controller integrates the principles of both proportional-integral-derivative (PID) and fractional-order proportional-integral (FOPID) methodologies. The 3DOF-FOPIDN controller is configured to effectively govern systems that are nonlinear and exhibit uncertainties. Based on the fractional order calculus, the FOPIDN component of the controller adeptly responds to the nonlinear behaviors of the system. The distinctiveness of a control system lies in its degree of freedom (DOF), which reflects the capacity to independently tailor its closed-loop transfer functions. In view of traditional 2DOF-based controllers, the 3DOF system architecture presents enhanced set-point adaptability by incorporating three autonomous loops that are pivotal for shaping the response, augmenting system stability, and attenuating disturbances. Within this configuration, the 3DOF-FOPIDN serves as the principal controller, while the MPC assumes the role of the ancillary controller.

The control strategy is illustrated in FIG. 3.

$$FOPID = G ( s ) = {K}_{P} + \frac{{K}_{I}}{{S}^{λ}} + {K}_{D} {s}^{μ} \qquad ( 21 )$$

$${G}_{3 DOF - FOPIDN} ( S ) = {K}_{p} \{ R ( s ) \times {W}_{p} ( s ) - ( Y ( s ) + D ( s ) \times ff ) \} + \frac{{K}_{I} \{ R ( s ) - ( Y ( s ) + D ( s ) \times ff ) \}}{{s}^{λ} ( s )} + {K}_{D} \cdot {s}^{μ} ( \frac{N}{N + {s}^{μ}} ) \cdot \{ R ( s ) \times {W}_{D} ( s ) - ( Y ( s ) + D ( s ) \times ff ) \}$$

where, 0≤μ, λ≤1; 0≤Wₚ, W_{D}≤1. Furthermore, R(s) represents the error, Y(s) depicts the output system response (Hz) and D(s) means the disturbance. The output signal is transmitted to slave controller to perform the computation for an optimal signal to mitigate the frequency fluctuations.

The predictive vector output is represented by Yₚ(k)

$${Y}_{p} ( k ) = ϕ Z ( k ) + ψ Δ U ( k ) + {ψ}_{I} Δ {U}_{I} ( k ) \qquad ( 23 )$$

The gradient descent method of a predictive vector, i.e. ∂J(k)/ΔU(k)=0, is used to find control law u(k) and the resulting equations are applied.

$$Δ U ( k ) = {( {ψ}^{T} Q ψ + R )}^{- 1} {ψ}^{T} Q ( {Y}_{r} ( k ) - ϕ Z ( k ) - {ψ}_{I} Δ {U}_{I} ( k ) ) , \qquad ( 24 )$$

$$Δ u ( k ) = ( {E}_{{N}_{u}} {O}_{{N}_{u} ( P - 1 )} ) Δ U ( k ) \qquad ( 25 )$$

$$u ( k ) = Δ u ( k ) + u ( k - 1 ) \qquad ( 26 )$$

The constraint for MPC construction of the LFC problem is given as

$$min J ( k ) = min \{ {( {Y}_{p} ( k ) - {Y}_{r} ( k ) )}^{T} Q ( {Y}_{p} ( k ) - {Y}_{r} ( k ) ) + {( Δ u ( k ) )}^{T} R ( Δ u ( k ) ) \} \qquad ( 27 )$$

Future control and performance predicted error square is weighed using the parameters Q and R. Controller gain parameters are shown in Table 2.

TABLE 2
Controller gains parameters

| Multi- | SCA:3DOF- | | DSA- | | Disclosed |
|---|---|---|---|---|---|
| area | FOPIDN | GA:PI | FOPIDN | MPC | Controller |
| Area-1 | K_{P} = 1.305 | K_{P} = 3.087 | K_{P} = 1.305 | P = 11 | KP = 2.014 |
| | K_{I} = 0.8658 | K_{I} = 4.188 | K_{I} = 3.128 | M = 2.877 | KI = 0.605 |
| | K_{D} = 0.2987 | | K_{D} = 0.208 | R = 3.585 | KD = 0.177 |
| | W_{P} = 0.4289 | | λ = 0.709 | Q = 1.000 | WP = 0.6142 |
| | W_{D} = 0.1281 | | μ = 0.892 | | WD = 0.2128 |
| | G_{f} = 0.0190 | | | | Gf = 0.0190 |
| | | | | | MPC Parameters |
| | | | | | P = 10 |
| | | | | | M = 2.707 |
| | | | | | R = 3.275 |
| | | | | | Q = 1.000 |
| Area-2 | K_{P} = 2.305 | K_{P} = 5.200 | K_{P} = 2.725 | P = 10 | K_{P} = 1.814 |
| | K_{I} = 0.158 | K_{I} = 8.51 | K_{I} = 6.288 | M = 2.100 | K_{I} = 2.775 |
| | K_{D} = 0.3287 | | K_{D} = 0.211 | R = 3.780 | K_{D} = 0.0330 |
| | W_{P} = 0.120 | | λ = 0.979 | Q = 1.000 | W_{P} = 0.2841 |
| | W_{D} = 0.107 | | μ = 0.804 | | W_{D} = 0.2408 |
| | G_{f} = 0.0274 | | | | G_{f} = 0.0330 |
| | | | | | MPC Parameters |
| | | | | | P = 10 |
| | | | | | M = 3.237 |
| | | | | | R = 5.105 |
| | | | | | Q = 1.003 |

The system 100 of the present disclosure, illustrated through FIG. 1 to FIG. 3, is experimented and validated, and the results are discussed with reference to subsequent figures. The difference in demand and generation causes a perturbation in frequency which requires to be addressed in a short time. The system 100 of the present disclosure was simulated on MATLAB 2017a. The efficacy of the 3DOF-FOPIDN-MPC was evaluated under different load scenarios. First, step load variations of 1% and 3%; second, variable step load variations; third, random load changes.

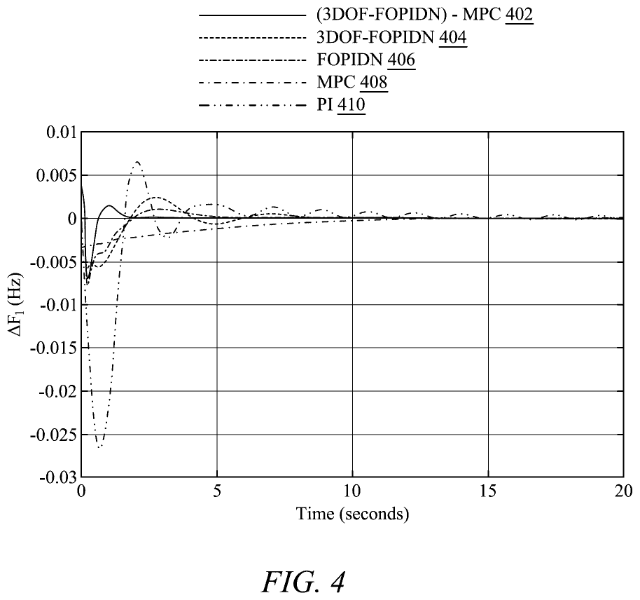

FIG. 4 illustrates frequency response versus time in seconds for a 1% load change in area-1. The controller has a response time of 1.115 seconds for a step load change of 1% in area 1. Reference numeral 402 indicates the performance of the (3DOF-FOPIDN)-MPC controller, while reference numeral 404 tracks the 3DOF-FOPIDN controller. A comparison with conventional controllers FOPIDN, MPC, and PI are correspondingly represented by reference numerals 406, 408, and 410. The 3DOF-FOPIDN-MPC controller 402 demonstrates a quicker attenuation of the frequency deviation, implying a more stable and effective control in comparison to the other controllers graphed.

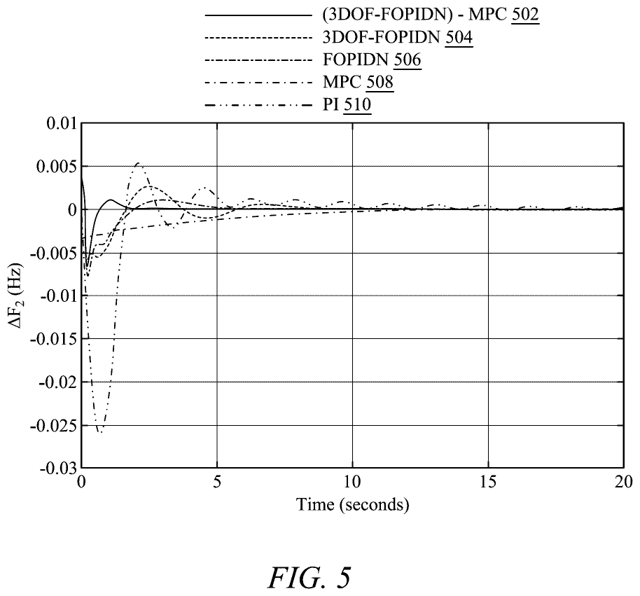

FIG. 5 illustrates frequency response versus time in seconds for a 1% load change in area-2. The controller has a response time of 1.118 seconds in area 2. The graph captures the efficacy of various controllers with the (3DOF-FOPIDN)-MPC controller denoted by reference numeral 502. It shows a superior frequency stabilization compared to the performances of 3DOF-FOPIDN (504), FOPIDN (506), MPC (508), and PI (510) controllers, as denoted by their respective reference numerals.

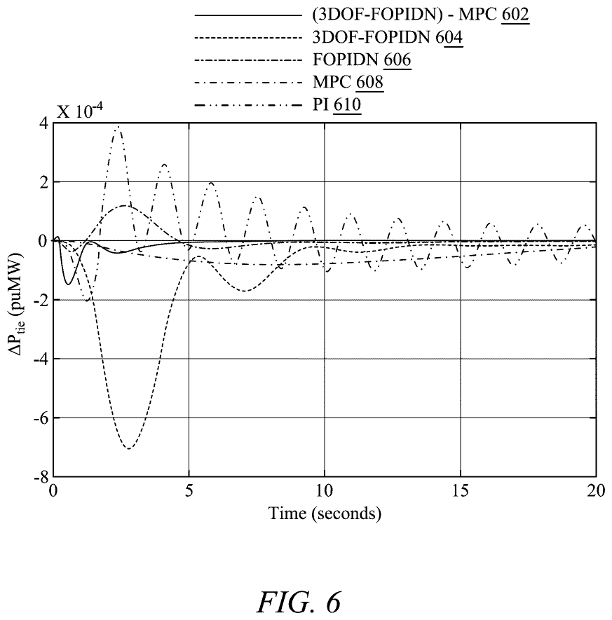

FIG. 6 illustrates tie-line power exchange versus time in seconds for a 1% load change, in accordance with an aspect of the present disclosure. The tie-line power exchange, ΔPₜᵢₑ, as a consequence of the 1% load change, tracked across the same time frame. The (3DOF-FOPIDN)-MPC controller displayed a quick output response to dampen frequency variations caused by an abrupt change in load, while the other controllers showed slow convergence response and vacillation around the reference frequency. Furthermore, the responses of the controllers were assessed by raising the abrupt load demand by 3% and analyzing the results. The plot shows the swifter response and reduced oscillations of the (3DOF-FOPIDN)-MPC controller (602) compared to the 3DOF-FOPIDN (604), FOPIDN (606), MPC (608), and PI (610) controllers, indicating enhanced inter-area power flow management capabilities.

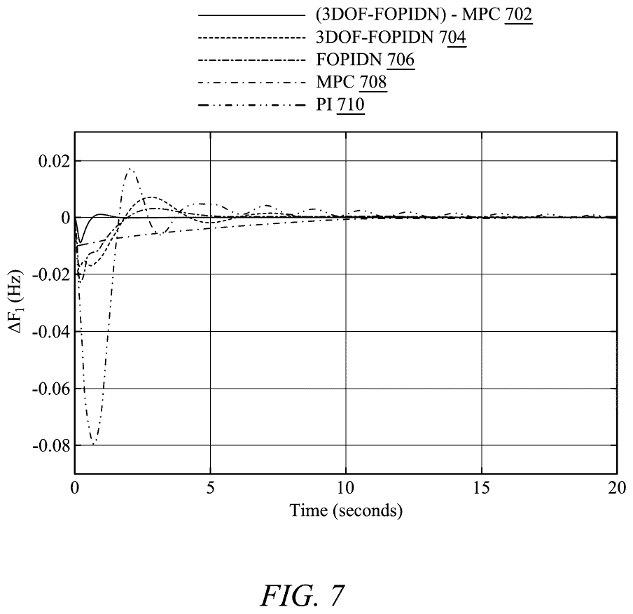

FIG. 7 illustrates frequency response versus time in seconds at 3% load change in area-1. FIG. 7 represents a 1.78 second frequency response time, denoted as ΔFₜ, within Area-1 following a 3% load alteration. The curve 702 indicates the frequency response for the (3DOF-FOPIDN)-MPC controller, which effectively minimized frequency oscillations and exhibited rapid stabilization back to the nominal frequency, indicating an optimal damping characteristic. The curve 704 indicates frequency response for the 3DOF-FOPIDN controller, which displayed competent control performance but with a marginally delayed return to steady-state conditions in comparison to the (3DOF-FOPIDN)-MPC. The curve 706 indicates frequency response for the FOPIDN controller shows a more pronounced initial frequency deviation, reflecting a slower response to counteract the introduced load change. The curve 708 indicates frequency response for the MPC controller, though effective in eventually dampening the frequency variations, does so with a less immediate response than the (3DOF-FOPIDN)-MPC. The curve 710 indicates frequency response for the PI controller, demonstrates the longest period of frequency deviation before stabilizing, representing the relative inefficiency of traditional PI control strategies in handling such significant load changes.

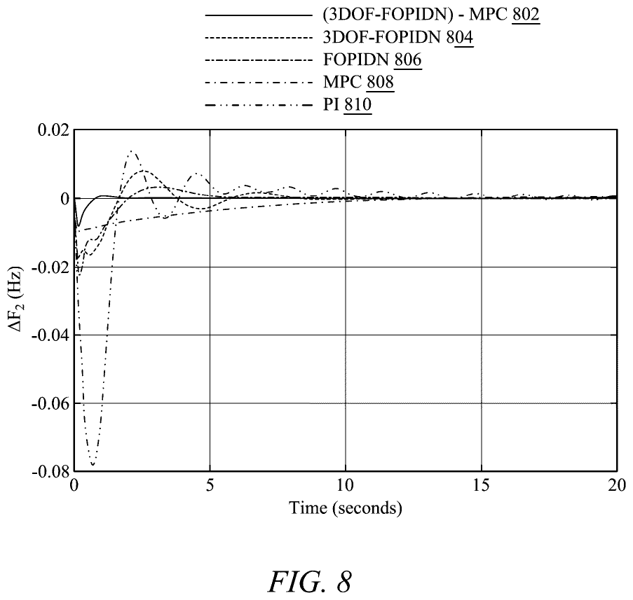

FIG. 8 illustrates the frequency response versus time in seconds at 3% load change in area-2. FIG. 8 represents a 1.81 second frequency response time, denoted as ΔF₁, within area-2 over a period of 20 seconds following a 3% load alteration.

The graph contrasts the effectiveness of the same set of controllers as in FIG. 7, over the same duration, with respective curve 802 for the 3DOF-FOPIDN-MPC controller, 804 for 3DOF-FOPIDN, 806 for FOPIDN, 808 for MPC, and 810 for PI. Consistent with the previous observations, the 3DOF-FOPIDN-MPC controller results in dampening the frequency oscillations and achieving rapid stabilization, thereby demonstrating its robustness and effectiveness.

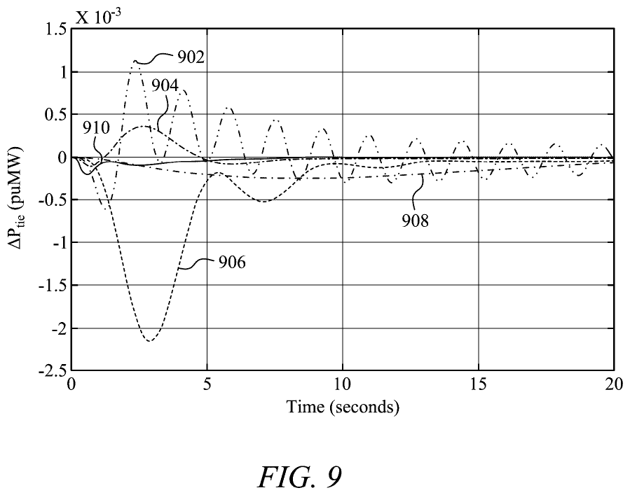

FIG. 9 illustrates a tie-line power exchange versus time in seconds for a 3% load change, in accordance with an aspect of the present disclosure. The graph indicates the tie-line power exchange ΔPₜᵢₑ in area-1 and area-2, post a 3% load change. The 3DOF-FOPIDN-MPC controller is observed to maintain a stable power exchange between the areas, shown by its minimal oscillatory behaviour and quick return to a steady state by curve 902. Similarly, curve 904 indicates the response of the 3DOF-FOPIDN controller, curve 906 indicates the response of the FOPIDN controller, curve 908 indicates the response of the MPC controller, and curve 910 indicates the response of the PI controllers.

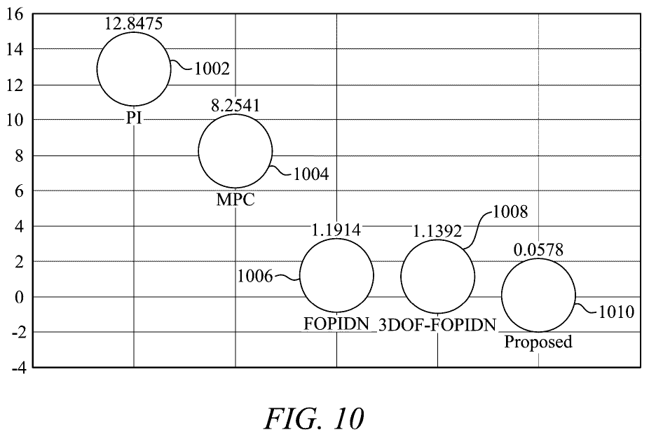

FIG. 10 illustrates a bubble chart depicting the integral of time-weighted absolute error (ITAE) performance indices for various controllers following a step load change, in accordance with an aspect of the present disclosure. Size of each bubble is proportional to the ITAE value, representing the magnitude of deviation from the desired performance, the smaller the ITAE, the better the performance of controller.

The PI controller is indicated by the largest bubble 1002 and the highest ITAE value of 12.8475, signifying the least effective performance among the depicted controllers. The MPC controller, depicted with a smaller bubble 1004 and an ITAE of 8.2541, shows an improvement over the PI controller but still lags in performance compared to the others. The FOPIDN controller, indicated by a bubble 1006 with an ITAE of 1.1914, reflects a better control outcome as seen by the reduced bubble size. Similarly, the 3DOF-FOPIDN controller, indicated by a bubble 1008 with an ITAE to 1.1392, presents a superior response to load changes than the standard FOPIDN controller. The smallest bubble 1010 (labelled “proposed”) represents the 3DOF-FOPIDN-MPC controller, with the lowest ITAE value of 0.0578, and delivers the most desirable performance by significantly minimizing the error and providing the most rapid and accurate return to the desired operating point post a step load change.

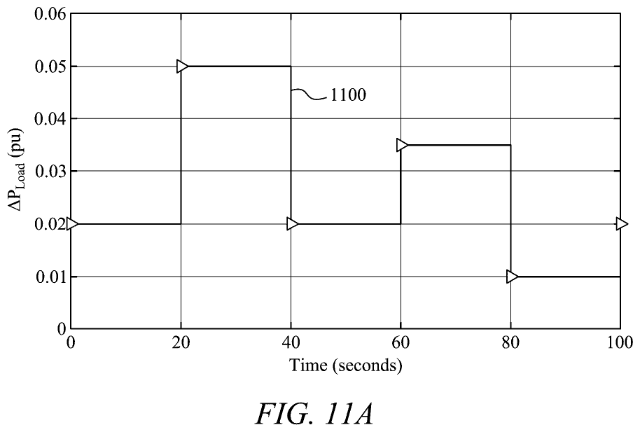

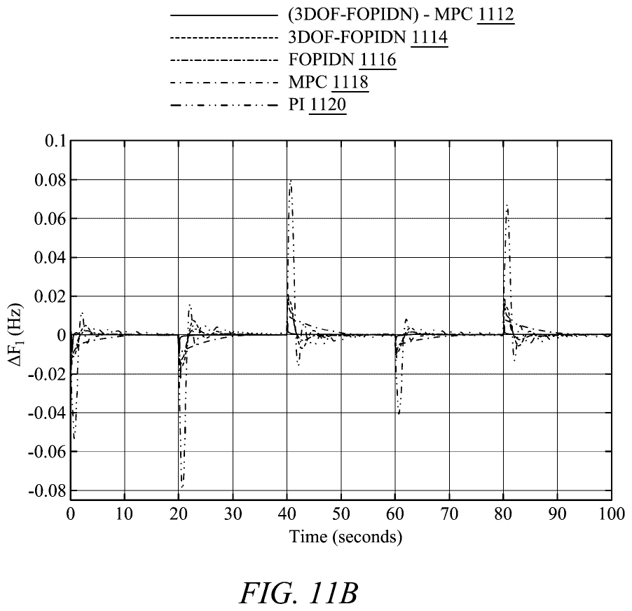

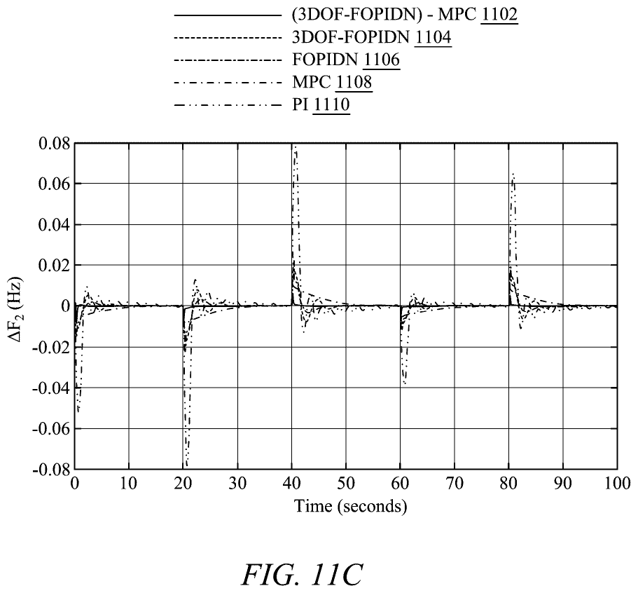

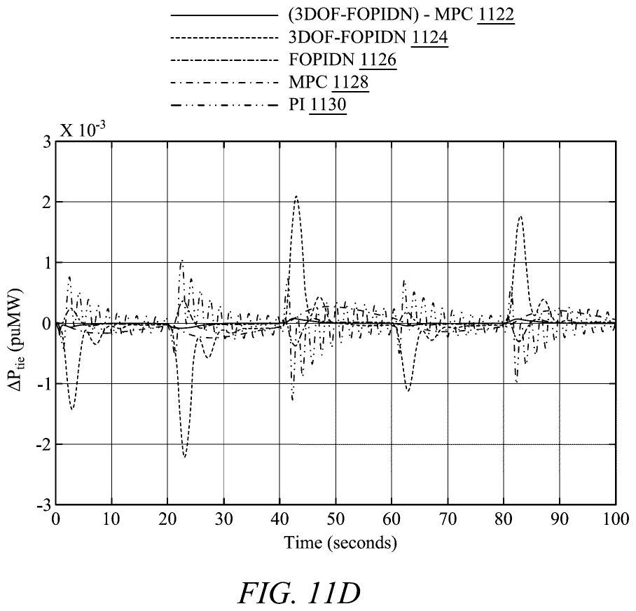

FIG. 11A-D provides a comprehensive evaluation of the controller performance under variable load conditions, each graph representing different aspects of the response of the controller to the load change.

FIG. 11A showcases the variation in the load applied to the system over time, marked with reference numeral 1100. The step changes illustrate the moments where the load increases, testing the ability of the controller to adapt and maintain stability.

FIG. 11B displays the frequency response Δf₁ in area-1 corresponding to the variable load changes. The graph provides insights into how each controller copes with the dynamic load. Curve 1102 represents a response of the 3DOF-FOPIDN-MPC controller, curve 1104 represents a response of the 3DOF-FOPIDN controller, curve 1106 represents a response of the FOPIDN controller, curve 1108 represents a response of the MPC controller, and curve 1110 represents response of the PI controller. The graph shows the ability of the 3DOF-FOPIDN-MPC controller to quickly stabilize frequency fluctuations.

FIG. 11C presents the frequency response Δf₂ in Area-2. Curve 1112 represents a response of the 3DOF-FOPIDN-MPC controller, curve 1114 represents a response of the 3DOF-FOPIDN controller, curve 1116 represents a response of the FOPIDN controller, curve 1118 represents a response of the MPC controller, and curve 1120 represents a response of the PI controller. The graph shows the proficiency of the 3DOF-FOPIDN-MPC controller in ensuring a rapid and robust response across different areas of the grid.

FIG. 11D depicts the tie-line power exchange ΔPₜᵢₑ, illustrating the effectiveness of the controllers in managing power flow between the interconnected areas during variable load conditions. Curve 1122 represents response of the 3DOF-FOPIDN-MPC controller, curve 1124 represents response of the 3DOF-FOPIDN controller, curve 1126 represents response of the FOPIDN controller, curve 1128 represents response of the MPC controller, and curve 1130 represents response of the PI controller. The graph illustrates the capability of the 3DOF-FOPIDN-MPC controller to minimize oscillations and maintain a balanced power distribution.

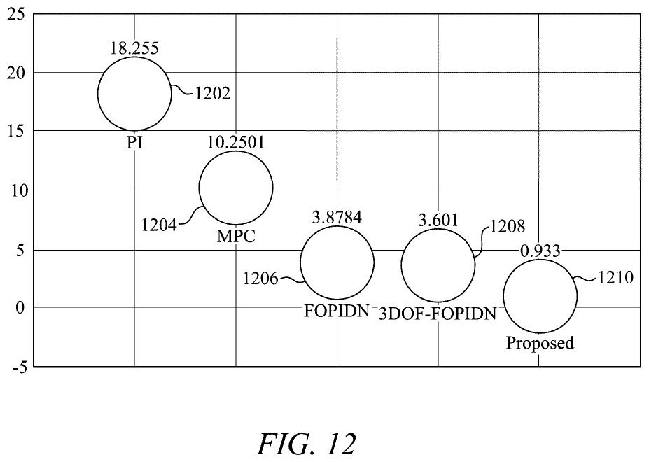

FIG. 12 is a bubble chart presenting a comparative performance analysis of various controllers using the ITAE performance index. The graph depicts different controllers, with the PI controller at a bubble 1202 exhibiting the highest ITAE value of 18.255, indicating less effective performance. The MPC controller response is indicated by a bubble 1204 with ITAE value of 10.2501. The FOPIDN controller response is indicated by a bubble 1206 with ITAE value of 3.8784. The 3DOF-FOPIDN controller response is indicated by a bubble 1208 with ITAE value of 3.601. The 3DOF-FOPIDN-MPC controller response is indicated by a bubble 1208 with lowest ITAE value of 0.933 demonstrating superior load disturbance rejection and system recovery speed.

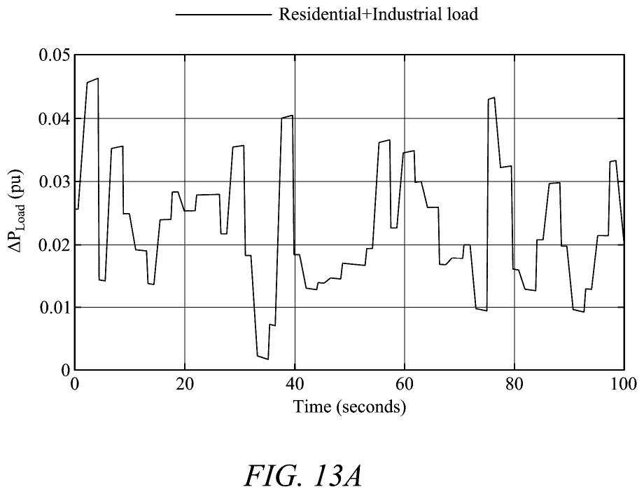

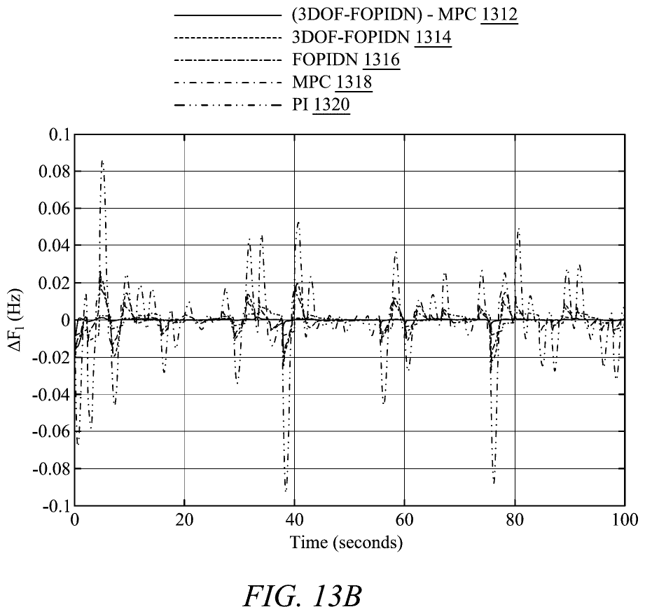

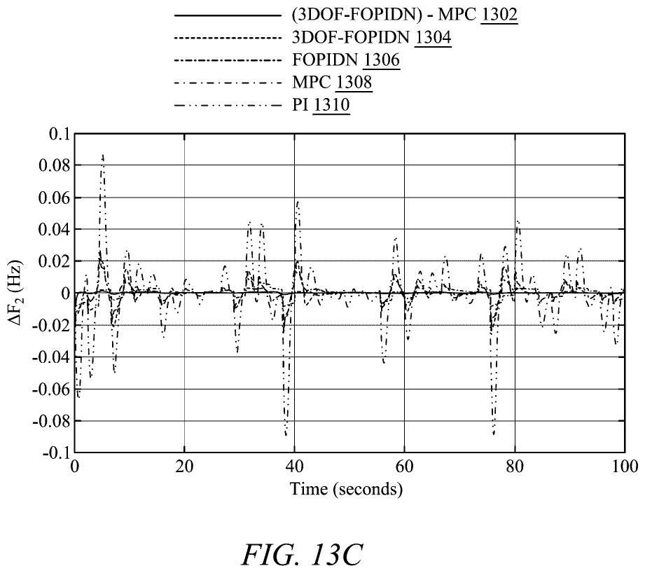

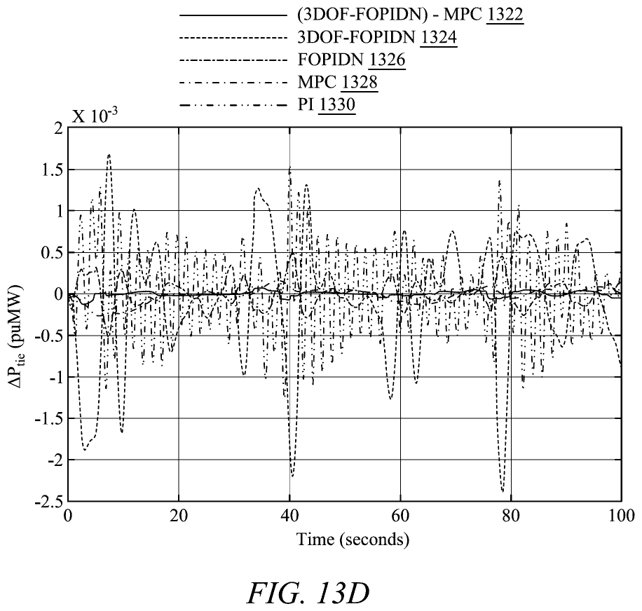

FIG. 13A-13D examine controller performance under random load variations within a power system. FIG. 13A presents the fluctuations in load, emphasizing the stochastic nature of the load changes that a power system might encounter.

FIG. 13B depicts the response of area-1 frequency (ΔF₁) to these load variations. Curve 1302 represents a response of the 3DOF-FOPIDN-MPC controller, curve 1304 represents a response of the 3DOF-FOPIDN controller, curve 1306 represents a response of the FOPIDN controller, curve 1308 represents a response of the MPC controller, and curve 1310 represents a response of the PI controller.

Similarly, FIG. 13C illustrates the frequency response (Δf₂) in area-2 under the same conditions. Curve 1312 represents the response of the 3DOF-FOPIDN-MPC controller, curve 1314 represents the response of the 3DOF-FOPIDN controller, curve 1316 represents the response of the FOPIDN controller, curve 1318 represents the response of the MPC controller, and curve 1320 represents the response of the PI controller.

FIG. 13D presents the power distribution (ΔPₜᵢₑ) between the two areas, reflecting the ability of the controller to manage inter-area power exchanges. Curve 1322 represents the response of the 3DOF-FOPIDN-MPC controller, curve 1324 represents the response of the 3DOF-FOPIDN controller, curve 1326 represents the response of the FOPIDN controller, curve 1328 represents the response of the MPC controller, and curve 1330 represents the response of the PI controller.

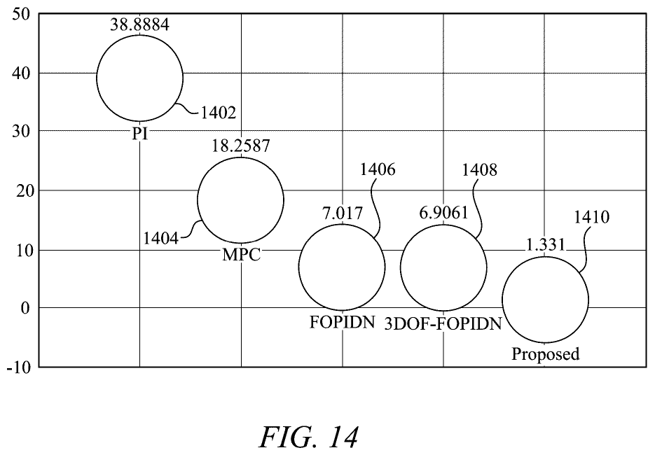

FIG. 14 evaluates controller performance in a scenario where the load changes randomly, capturing the volatility of real-world power system dynamics. The graph depicts different controllers, with the PI controller at a bubble 1402 exhibiting the highest ITAE value of 38.8884, indicating less effective performance. The MPC controller response is indicated by a bubble 1404 with ITAE value of 18.2587. The FOPIDN controller response is indicated by a bubble 1406 with ITAE value of 7.017. The 3DOF-FOPIDN controller response is indicated by a bubble 1408 with ITAE value of 6.9061. The 3DOF-FOPIDN-MPC controller response is indicated by a bubble 1408 with lowest ITAE value of 1.331. The 3DOF-FOPIDN-MPC controller demonstrates a superior ability to maintain system stability and achieve quick frequency normalization post disturbance.

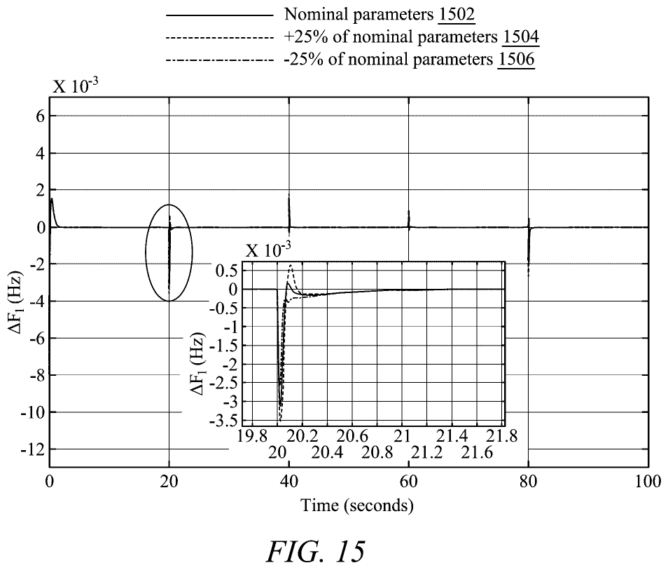

FIG. 15 illustrates a sensitivity analysis of the disclosed controller for area 1. The graph plots the frequency deviation over time with three sets of parameter values. First, nominal parameters, as presented by curve 1502; second, nominal parameters increased by 25%, as presented by curve 1504; and third, nominal parameters decreased by 25%, as presented by curve 1506. An inset zooms in on a segment of the response curve, presenting the reaction of the controller to a parameter variance.

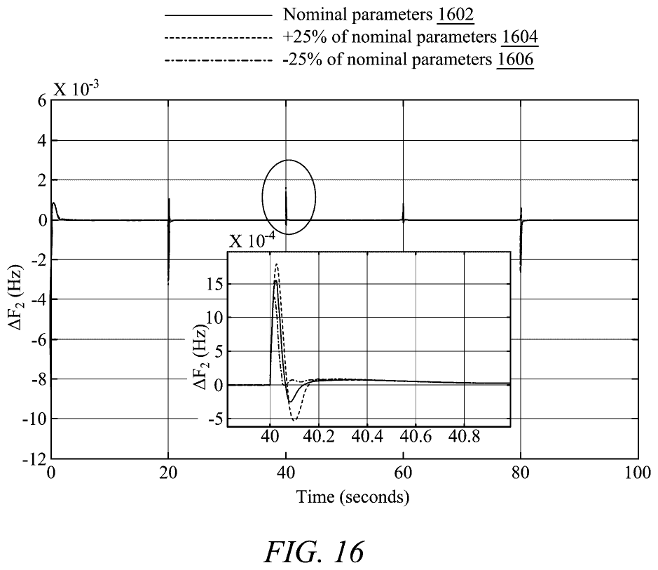

FIG. 16 illustrates the sensitivity analysis of the designed controller for area 2, displaying the frequency response Δf₂ for three different parameter conditions. First, nominal parameters, as presented by curve 1602; second, nominal parameters increased by 25%, as presented by curve 1604; and third, nominal parameters decreased by 25%, as presented by curve 1606. The inset shows the frequency deviation over time, emphasizing the ability of the controller to adapt to parameter changes and maintain effective control over the frequency stability of the system.

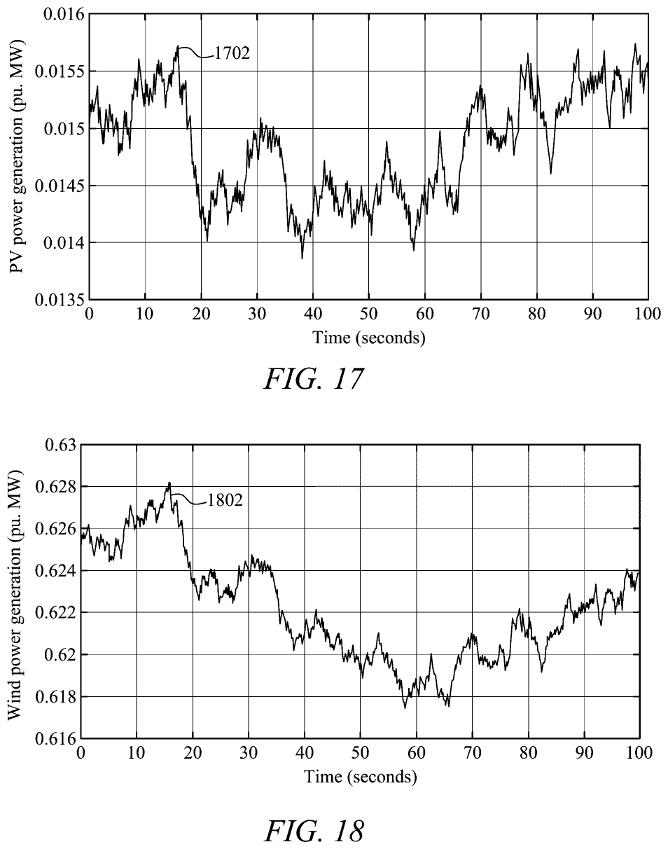

FIG. 17 illustrates the response of photovoltaic (PV) power generation to the implemented controller, in accordance with an aspect of the present disclosure. The PV power generation, indicated by curve 1702, is shown to fluctuate over time, indicating the variable nature of solar energy input due to environmental factors. The controller's management of such variability is crucial to ensure continuous stability and performance within the power system.

FIG. 18 illustrates the response of wind power generation under the influence of the applied controller. With reference to curve 1802, it is evident that the wind power output is subject to change, reflecting the intermittent and unpredictable nature of wind resources. The controller must compensate for these variations and provide a reliable and consistent frequency response despite the inherent variability in wind power generation.

The present disclosure as described through FIG. 1-FIG. 18. In accordance with one embodiment, a load frequency control system for integrating interconnected power sources with renewable energy sources is disclosed.

The system includes a first power system located in a first geographic region and a second power system located in a second geographic region, wherein the first power system and the second power system are connected by an inter-area tie-line, wherein each power system includes a three degrees of freedom fractional order proportional integral derivative (3DOF-FOPIDN) controller, wherein the 3DOF-FOPIDN controller includes electrical circuitry, a memory having program instructions including a salp swarm algorithm stored therein and at least one processor configured to execute the salp swarm algorithm to update a set of gain parameters of the 3DOF-FOPIDN controller, a model predictive controller (MPC) operatively connected to the 3DOF-FOPIDN controller, a droop control unit connected to the MPC, a plurality of renewable energy resources connected to the droop control unit, a first adder connected to the plurality of renewable energy resources, wherein the first adder is configured to receive a power deviation signal from each of the plurality of renewable energy resources, add the power deviation signal and generate a total power deviation signal, a load center configured to generate a load power perturbation signal, a subtractor operatively connected to receive the total power deviation signal, the load power perturbation signal, and an inter-area tie line power deviation signal ΔPₜᵢₑ, wherein the subtractor is configured to subtract the load power perturbation signal and the inter-area tie-line power deviation signal from the total power deviation signal, and generate a power deviation difference signal, a frequency generator connected to the subtractor, wherein the frequency generator is configured to receive the power deviation difference signal and output a frequency deviation value, a feedback loop configured to transmit the frequency deviation value to a bias factor generator, wherein the bias factor generator is configured to generate a bias factor based on the frequency deviation value, and a second adder configured to receive the bias factor and the inter-area tie line power deviation signal and generate an area control error (ACE) signal, wherein the 3DOF-FOPIDN controller is configured to receive the ACE signal from the second adder, update a set of gain parameters, generate frequency error correction signals and transmit the frequency error correction signals to the MPC, wherein the MPC is configured to generate droop error correction signals based on the frequency error correction signals and transmit the droop error correction signals to the droop control unit.

In one aspect, the system includes an inter-area adder connected to the frequency generator of the first power system and to the frequency generator of the second power system, wherein the inter-area adder is configured to add the frequency deviation value of the first power system to the frequency deviation value of the second power system and generate a negative sum of the frequency deviation values, and a synchronization generator connected to the inter-area adder, wherein the synchronization generator is configured to receive the negative sum of the frequency deviation values and generate the inter-area tie line power deviation signal.

In one aspect, the droop control unit of each power system is configured to receive the frequency deviation value from the feedback loop, generate negative droop values for each of the renewable energy sources, add the droop error correction signals to the negative droop values of each of the renewable energy sources, generate corrected droop values and transmit the corrected droop values to the renewable energy sources, wherein the corrected droop values are configured to minimize frequency imbalances due to load disturbances in the power generation of the plurality of renewable energy sources of each power system.

The renewable energy sources include at least one of a thermal generator, a photovoltaic energy generator, and a wind energy generator.

The 3DOF-FOPIDN controller of each power system is a master controller configured to execute the salp swarm algorithm to minimize a cost function J to update the set of gain parameters of the 3DOF-FOPIDN controller, and the MPC is a slave to the master controller.

The set of gain parameters of each power system includes a proportional gain Kₚ, an integral gain Kᵢ, and a derivative gain K_{d}, wherein each of the gain parameters is within a range of 0 to 15.

The set of gain parameters of each power system further includes a first control vector μ and a second control vector λ, wherein 0≤μ≤1 and 0≤λ≤1, and a filter factor N of the 3DOF-FOPIDN controller is within a range of 1 to 300.

The cost function J is an integral time absolute error given by J=ITAE=∫₀^{∞}t(|Δf₁|+|Δf₂|+|ΔPₜᵢₑ|)dt, where t is time, Δf₁ is the frequency deviation value of the first power system and Δf₂ is the frequency deviation value of the second power system.

In another embodiment, a method for controlling load frequency deviations in a first power system located in a first geographic region and a second power system located in a second geographic region, each power system including power sources and a plurality of renewable energy sources is disclosed. The method includes interconnecting the first power system and the second power system by an inter-area tie-line, installing, within each power system, a three degrees of freedom fractional order proportional integral derivative (3DOF-FOPIDN) controller, the 3DOF-FOPIDN controller including electrical circuitry, a memory having program instructions including a salp swarm algorithm stored therein and at least one processor configured for executing the salp swarm algorithm and updating a set of gain parameters of the 3DOF-FOPIDN controller, connecting a model predictive controller (MPC) to the 3DOF-FOPIDN controller, connecting a droop control unit to an output terminal of the MPC, connecting the plurality of renewable energy resources to output signal lines of the droop control unit, connecting a first adder to each of the plurality of renewable energy resources, wherein the first adder is configured for receiving a power deviation signal from each of the plurality of renewable energy resources, adding the power deviation signal and generating a total power deviation signal, connecting a subtractor to the first adder, receiving, by the subtractor, the total power deviation signal, an inter-area tie line power deviation signal ΔPtie and a load power perturbation signal of a load center, subtracting, by the subtractor, the load power perturbation signal and the inter-area tie-line power deviation signal from the total power deviation signal, and generating a power deviation difference signal, connecting a frequency generator to the subtractor, receiving, by the frequency generator, the power deviation difference signal and generating a frequency deviation value, connecting a feedback loop to an output of the frequency generator, and transmitting the frequency deviation value to a bias factor generator, generating, by the bias factor generator, a bias factor based on the frequency deviation value, and connecting a second adder to the bias factor generator and the inter-area tie line, receiving, by the second adder, the bias factor and the inter-area tie line power deviation signal and generating an area control error (ACE) signal, connecting the second adder to the 3DOF-FOPIDN controller, receiving, by the 3DOF-FOPIDN controller, the ACE signal from the second adder, updating the set of gain parameters, generating frequency error correction signals and transmitting the frequency error correction signals to the MPC, and generating, by the MPC, droop error correction signals based on the frequency error correction signals and transmitting, by the MPC, the droop error correction signals to the droop control unit.

In one aspect, the method includes connecting an inter-area adder to the frequency generator of the first power system and to the frequency generator of the second power system, adding, by the inter-area adder, the frequency deviation value of the first power system to the frequency deviation value of the second power system and generating, by the inter-area adder, a negative sum of the frequency deviation values, connecting a synchronization generator to the inter-area adder, and receiving, by the synchronization generator, the negative sum of the frequency deviation values and generating the inter-area tie line power deviation signal.

In one aspect, the method includes receiving, by the droop control unit of each power system, the frequency deviation value from the feedback loop, generating, by the droop control unit, negative droop values for each of the renewable energy sources, adding, by the droop control unit, the droop error correction signals to the negative droop values of each of the renewable energy sources, generating, by the droop control unit, corrected droop values, transmitting, the droop control unit, the corrected droop values to the renewable energy sources, and minimizing, by the corrected droop values, frequency imbalances due to load disturbances in the power generation of the plurality of renewable energy sources of each power system.

In one aspect, the method includes executing, by the 3DOF-FOPIDN controller of each power system, the salp swarm algorithm to minimize a cost function J, and updating, by the 3DOF-FOPIDN controller of each power system, the set of gain parameters of the 3DOF-FOPIDN controller.

In one aspect, the method includes calculating the cost function J as an integral time absolute error given by J=ITAE=∫₀^{∞}t(|Δf₁|+|Δf₂|+|ΔPₜᵢₑ|)dt, where t is time, Δf₁ is the frequency deviation value of the first power system and Δf₂ is the frequency deviation value of the second power system.

In one aspect, the method includes controlling, by the 3DOF-FOPIDN controller, a proportional gain Kₚ, an integral gain Kᵢ, and a derivative gain K_{d} of the set of gain parameters of each power system to be within a range of 0 to 15.

In one aspect, the method includes controlling, by the 3DOF-FOPIDN controller, a first control vector μ of the set of gain parameters of each power system to be within a range of 0≤μ≤1.

In one aspect, the method includes controlling, by the 3DOF-FOPIDN controller, a second control vector λ of the set of gain parameters of each power system to be within a range of 0≤λ≤1.

In one aspect, the method includes controlling, by the 3DOF-FOPIDN controller, a filter factor N of the FOPIDN controller to be within a range of 1 to 300.

In another embodiment, a hybrid controller configured to integrate interconnected power sources with renewable energy sources in a first power system located in a first geographic region and a second power system located in a second geographic region, wherein the first power system and the second power system are connected by an inter-area tie-line is disclosed. The hybrid controller includes a three degrees of freedom fractional order proportional integral derivative (3DOF-FOPIDN) controller located in each power system, wherein the 3DOF-FOPIDN controller includes a receiver configured to receive an area control error (ACE) signal from the respective power system, an electrical circuitry, a memory having program instructions, wherein the program instructions include a salp swarm algorithm stored therein, and at least one processor configured to execute the salp swarm algorithm to update a set of gain parameters of the 3DOF-FOPIDN controller based on the ACE of each power system, and a slave model predictive controller (MPC) operatively connected to the 3DOF-FOPIDN controller of each power system, wherein the slave MPC is configured to generate a set of droop error correction signals and transmit the droop error correction signals to renewable energy sources.

In one aspect, the hybrid controller includes a cost function J stored within the program instructions, wherein the processor of each power system is configured to execute the salp swarm algorithm to minimize the cost function J.

In one aspect, the hybrid controller includes the set of gain parameters of each power system includes a proportional gain Kp, an integral gain Ki, and a derivative gain Kd, wherein each of the gain parameters is within a range of 0 to 15, the set of gain parameters of each power system further includes a first control vector μ and a second control vector λ, wherein 0≤μ≤1 and 0≤λ≤1, a filter factor N of the 3DOF-FOPIDN controller of each power system is selected to be in a range of 1 to 300, and the cost function J is an integral time absolute error given by: J=ITAE=∫₀^{∞}t(|Δf₁|+|Δf₂|+|ΔPₜᵢₑ|)dt, where t is time, Δf₁ is a frequency deviation value of the first power system and Δf₂ is a frequency deviation value of the second power system.

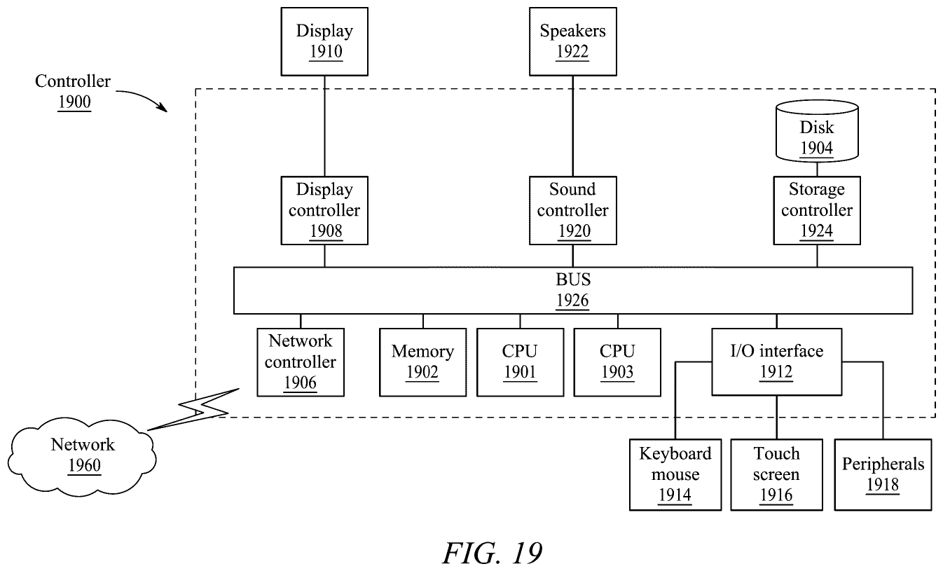

Next, further details of the hardware description of the computing environment of FIG. 1 according to exemplary embodiments are described with reference to FIG. 19. In FIG. 19, a controller 1900 is described as representative of the 3DOF-FOPIDN controller 102 and the 3DOF-FOPIDN controllers 110 of FIG. 1, each of which may include a CPU 1901 which performs the processes described above/below. The process data and instructions may be stored in memory 1902. These processes and instructions may also be stored on a storage medium disk 1904 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1901, 1903 and an operating system such as Microsoft Windows 7, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 1901 or CPU 1903 may be a Xenon or Core processor from Intel of America or an Opteron processor from AMD of America, or may be other processor types that would be recognized by one of ordinary skill in the art. Alternatively, the CPU 1901, 1903 may be implemented on an FPGA, ASIC, PLD or using discrete logic circuits, as one of ordinary skilled in the art would recognize. Further, C P U 1901, 1903 may be implemented as multiple processors cooperatively working in parallel to perform the instructions of the inventive processes described above.

The computing device in FIG. 19 also includes a network controller 1906, such as an Intel Ethernet PRO network interface card from Intel Corporation of America, for interfacing with network 1960. As can be appreciated, the network 1960 can be a public network, such as the Internet, or a private network such as an LAN or WAN network, or any combination thereof and can also include PSTN or ISDN sub-networks. The network 1960 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device further includes a display controller 1908, such as a NVIDIA GeForce GTX or Quadro graphics adaptor from NVIDIA Corporation of America for interfacing with display 1910, such as a Hewlett Packard HPL2445w LCD monitor. A general purpose I/O interface 1912 interfaces with a keyboard and/or mouse 1914 as well as a touch screen panel 1916 on or separate from display 1917. General purpose I/O interface also connects to a variety of peripherals 1917 including printers and scanners, such as an OfficeJet or DeskJet from Hewlett Packard.

A sound controller 1920 is also provided in the computing device such as Sound Blaster X-Fi Titanium from Creative, to interface with speakers/microphone 1922 thereby providing sounds and/or music.

The general-purpose storage controller 1924 connects the storage medium disk 1904 with communication bus 1926, which may be an ISA, EISA, VESA, PCI, or similar, for interconnecting all of the components of the computing device. A description of the general features and functionality of the display 1918, keyboard and/or mouse 1914, as well as the display controller 1908, storage controller 1924, network controller 1906, sound controller 1920, and general purpose I/O interface 1912 is omitted herein for brevity as these features are known.

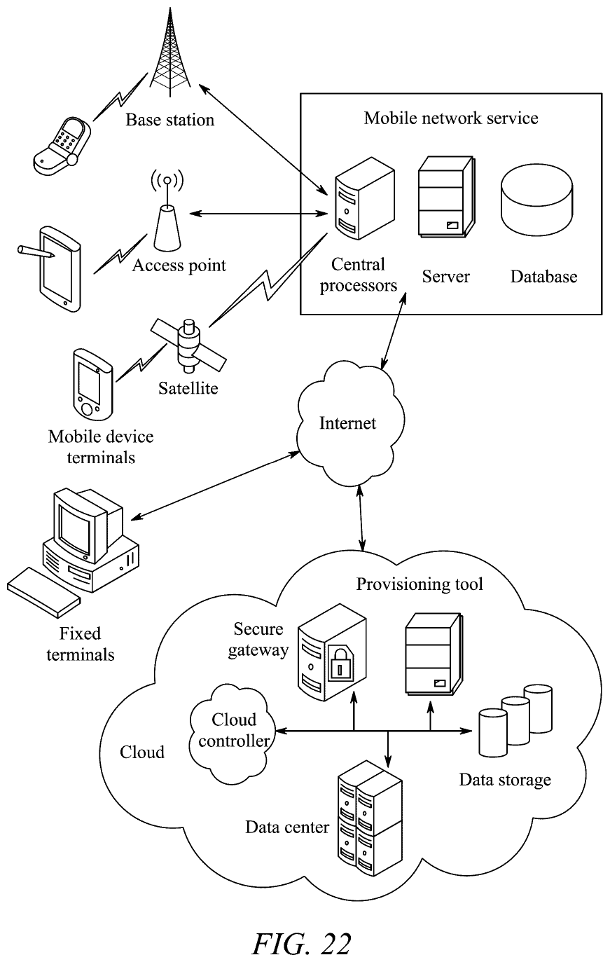

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown in FIG. 22.

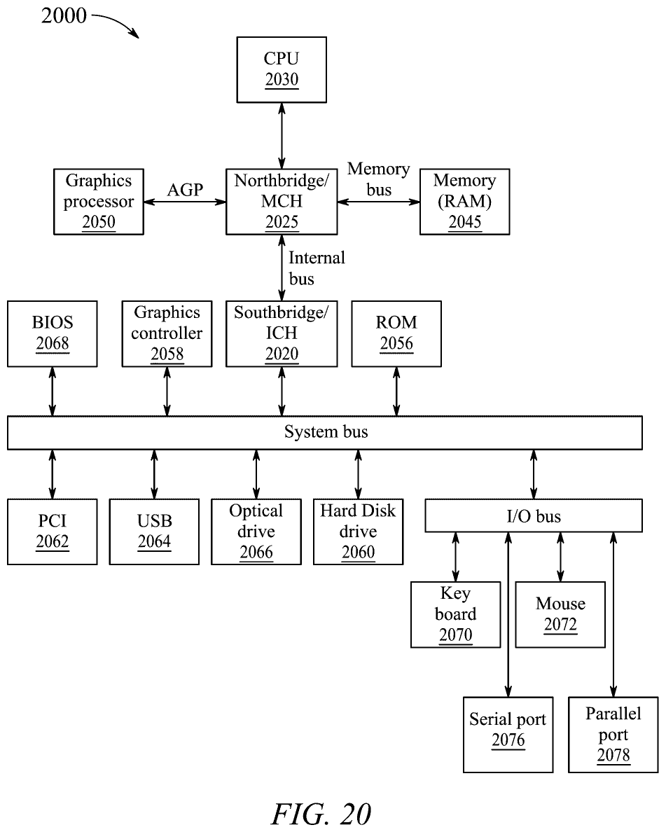

FIG. 20 shows a schematic diagram of a data processing system, according to certain embodiments, for performing the functions of the exemplary embodiments. The data processing system is an example of a computer in which code or instructions implementing the processes of the illustrative embodiments may be located.

In FIG. 20, data processing system 2000 employs a hub architecture including a north bridge and memory controller hub (NB/MCH) 2025 and a south bridge and input/output (I/O) controller hub (SB/ICH) 2020. The central processing unit (CPU) 2030 is connected to NB/MCH 2025. The NB/MCH 2025 also connects to the memory 2045 via a memory bus, and connects to the graphics processor 2050 via an accelerated graphics port (AGP). The NB/MCH 2025 also connects to the SB/ICH 2020 via an internal bus (e.g., a unified media interface or a direct media interface). The CPU Processing unit 2030 may contain one or more processors and even may be implemented using one or more heterogeneous processor systems.

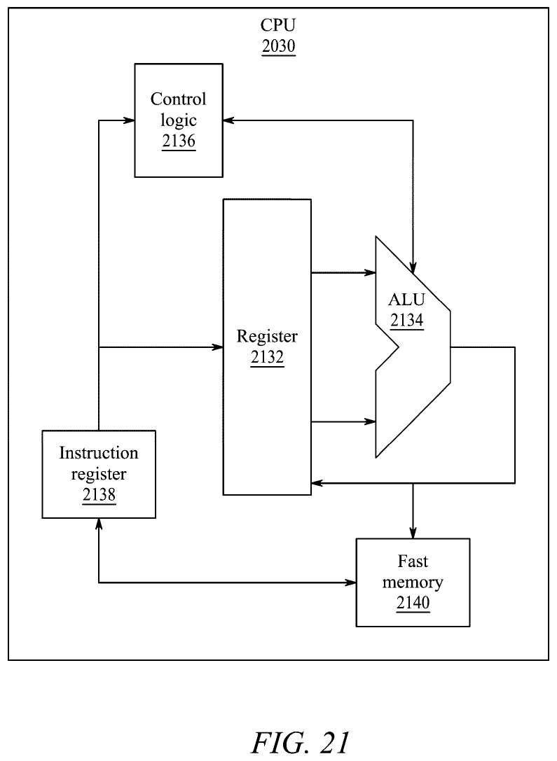

For example, FIG. 21 shows one implementation of CPU 2030. In one implementation, the instruction register 2138 retrieves instructions from the fast memory 2140. At least part of these instructions is fetched from the instruction register 2138 by the control logic 2136 and interpreted according to the instruction set architecture of the CPU 1130. Part of the instructions can also be directed to the register 2132. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 2134 that loads values from the register 2132 and performs logical and mathematical operations on the loaded values according to the instructions. The results from these operations can be feedback into the register and/or stored in the fast memory 2140. According to certain implementations, the instruction set architecture of the CPU 2130 can use a reduced instruction set architecture, a complex instruction set architecture, a vector processor architecture, a very large instruction word architecture. Furthermore, the CPU 2130 can be based on the Von Neuman model or the Harvard model. The CPU 2130 can be a digital signal processor, an FPGA, an ASIC, a PLA, a PLD, or a CPLD. Further, the CPU 2130 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 20, the data processing system 2000 can include that the SB/ICH 2020 is coupled through a system bus to an I/O Bus, a read only memory (ROM) 856, universal serial bus (USB) port 2064, a flash binary input/output system (BIOS) 2068, and a graphics controller 2058. PCI/PCIe devices can also be coupled to SB/ICH 2088 through a PCI bus 2062.

The PCI devices may include, for example, Ethernet adapters, add-in cards, and PC cards for notebook computers. The Hard disk drive 2060 and CD-ROM 2066 can use, for example, an integrated drive electronics (IDE) or serial advanced technology attachment (SATA) interface. In one implementation the I/O bus can include a super I/O (SIO) device.

Further, the hard disk drive (HDD) 2060 and optical drive 2066 can also be coupled to the SB/ICH 2020 through a system bus. In one implementation, a keyboard 2070, a mouse 2072, a parallel port 2078, and a serial port 2076 can be connected to the system bus through the I/O bus. Other peripherals and devices that can be connected to the SB/ICH 2020 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended backup load to be powered.

The functions and features described herein may also be executed by various distributed components of a system. For example, one or more processors may execute these system functions, where the processors are distributed across multiple components communicating in a network. The distributed components may include one or more client and server machines, which may share processing, as shown by FIG. 22, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely, either in real-time or as a batch process. Additionally, some aspects of the present disclosures may be performed on modules or hardware that are not identical to those described. Accordingly, other aspects of the present disclosures are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A load frequency control system for integrating interconnected power sources with renewable energy sources, comprising:
a first power system located in a first geographic region and a second power system located in a second geographic region, wherein the first power system and the second power system are connected by an inter-area tie-line, wherein each power system includes:
a three degrees of freedom fractional order proportional integral derivative (3DOF-FOPIDN) controller, wherein the 3DOF-FOPIDN controller includes electrical circuitry, a memory having program instructions including a salp swarm algorithm stored therein and at least one processor configured to execute the salp swarm algorithm to update a set of gain parameters of the 3DOF-FOPIDN controller;
a model predictive controller (MPC) operatively connected to the 3DOF-FOPIDN controller;
a droop control unit connected to the MPC;
a plurality of renewable energy resources connected to the droop control unit;
a first adder connected to the plurality of renewable energy resources, wherein the first adder is configured to receive a power deviation signal from each of the plurality of renewable energy resources, add the power deviation signal and generate a total power deviation signal;
a load center configured to generate a load power perturbation signal;
a subtractor operatively connected to receive the total power deviation signal, the load power perturbation signal, and an inter-area tie line power deviation signal ΔPₜᵢₑ, wherein the subtractor is configured to subtract the load power perturbation signal and the inter-area tie-line power deviation signal from the total power deviation signal, and generate a power deviation difference signal;
a frequency generator connected to the subtractor, wherein the frequency generator is configured to receive the power deviation difference signal and output a frequency deviation value;
a feedback loop configured to transmit the frequency deviation value to a bias factor generator, wherein the bias factor generator is configured to generate a bias factor based on the frequency deviation value; and
a second adder configured to receive the bias factor and the inter-area tie line power deviation signal and generate an area control error (ACE) signal,
wherein the 3DOF-FOPIDN controller is configured to receive the ACE signal from the second adder, update a set of gain parameters, generate frequency error correction signals and transmit the frequency error correction signals to the MPC,
wherein the MPC is configured to generate droop error correction signals based on the frequency error correction signals and transmit the droop error correction signals to the droop control unit.

2. The load frequency control system of claim 1, further comprising:
an inter-area adder connected to the frequency generator of the first power system and to the frequency generator of the second power system, wherein the inter-area adder is configured to add the frequency deviation value of the first power system to the frequency deviation value of the second power system and generate a negative sum of the frequency deviation values; and
a synchronization generator connected to the inter-area adder, wherein the synchronization generator is configured to receive the negative sum of the frequency deviation values and generate the inter-area tie line power deviation signal.

3. The load frequency control system of claim 1, wherein the droop control unit of each power system is configured to receive the frequency deviation value from the feedback loop, generate negative droop values for each of the renewable energy sources, add the droop error correction signals to the negative droop values of each of the renewable energy sources, generate corrected droop values and transmit the corrected droop values to the renewable energy sources, wherein the corrected droop values are configured to minimize frequency imbalances due to load disturbances in the power generation of the plurality of renewable energy sources of each power system.

4. The load frequency control system of claim 1, wherein the renewable energy sources include at least one of a thermal generator, a photovoltaic energy generator, and a wind energy generator.

5. The load frequency control system of claim 1, wherein:
the 3DOF-FOPIDN controller of each power system is a master controller configured to execute the salp swarm algorithm to minimize a cost function J to update the set of gain parameters of the 3DOF-FOPIDN controller, and
the MPC is a slave to the master controller.

6. The load frequency control system of claim 5, wherein the set of gain parameters of each power system includes a proportional gain Kₚ, an integral gain Kᵢ, and a derivative gain K_{d}, wherein each of the gain parameters is within a range of 0 to 15.

7. The load frequency control system of claim 6, wherein:
the set of gain parameters of each power system further includes a first control vector μ and a second control vector λ, wherein 0≤μ≤1 and 0≤λ≤1; and
a filter factor N of the 3DOF-FOPIDN controller is within a range of 1 to 300.

8. The load frequency control system of claim 7, wherein the cost function J is an integral time absolute error given by:
$$J = ITAE = {\int }_{0}^{∞} t ( \vert Δ {f}_{1} \vert + \vert Δ {f}_{2} \vert + \vert Δ {P}_{tie} \vert ) dt ,$$
where t is time, Δf₁ is the frequency deviation value of the first power system and Δf₂ is the frequency deviation value of the second power system.

9. A method for controlling load frequency deviations in a first power system located in a first geographic region and a second power system located in a second geographic region, each power system including power sources and a plurality of renewable energy sources, comprising:
interconnecting the first power system and the second power system by an inter-area tie-line;
installing, within each power system, a three degrees of freedom fractional order proportional integral derivative (3DOF-FOPIDN) controller, the 3DOF-FOPIDN controller including electrical circuitry, a memory having program instructions including a salp swarm algorithm stored therein and at least one processor configured for executing the salp swarm algorithm and updating a set of gain parameters of the 3DOF-FOPIDN controller;
connecting a model predictive controller (MPC) to the 3DOF-FOPIDN controller;
connecting a droop control unit to an output terminal of the MPC;
connecting the plurality of renewable energy resources to output signal lines of the droop control unit;
connecting a first adder to each of the plurality of renewable energy resources, wherein the first adder is configured for receiving a power deviation signal from each of the plurality of renewable energy resources, adding the power deviation signal and generating a total power deviation signal;
connecting a subtractor to the first adder;
receiving, by the subtractor, the total power deviation signal, an inter-area tie line power deviation signal ΔPₜᵢₑ and a load power perturbation signal of a load center;
subtracting, by the subtractor, the load power perturbation signal and the inter-area tie-line power deviation signal from the total power deviation signal, and generating a power deviation difference signal;
connecting a frequency generator to the subtractor;
receiving, by the frequency generator, the power deviation difference signal and generating a frequency deviation value;
connecting a feedback loop to an output of the frequency generator, and transmitting the frequency deviation value to a bias factor generator;
generating, by the bias factor generator, a bias factor based on the frequency deviation value; and
connecting a second adder to the bias factor generator and the inter-area tie line;
receiving, by the second adder, the bias factor and the inter-area tie line power deviation signal and generating an area control error (ACE) signal;
connecting the second adder to the 3DOF-FOPIDN controller;
receiving, by the 3DOF-FOPIDN controller, the ACE signal from the second adder, updating the set of gain parameters, generating frequency error correction signals and transmitting the frequency error correction signals to the MPC; and
generating, by the MPC, droop error correction signals based on the frequency error correction signals and transmitting, by the MPC, the droop error correction signals to the droop control unit.

10. The method of claim 9, further comprising:
connecting an inter-area adder to the frequency generator of the first power system and to the frequency generator of the second power system;
adding, by the inter-area adder, the frequency deviation value of the first power system to the frequency deviation value of the second power system and generating, by the inter-area adder, a negative sum of the frequency deviation values;
connecting a synchronization generator to the inter-area adder; and
receiving, by the synchronization generator, the negative sum of the frequency deviation values and generating the inter-area tie line power deviation signal.

11. The method of claim 10, further comprising:
receiving, by the droop control unit of each power system, the frequency deviation value from the feedback loop;
generating, by the droop control unit, negative droop values for each of the renewable energy sources;
adding, by the droop control unit, the droop error correction signals to the negative droop values of each of the renewable energy sources;
generating, by the droop control unit, corrected droop values;
transmitting, the droop control unit, the corrected droop values to the renewable energy sources; and
minimizing, by the corrected droop values, frequency imbalances due to load disturbances in the power generation of the plurality of renewable energy sources of each power system.

12. The method of claim 10, further comprising:
executing, by the 3DOF-FOPIDN controller of each power system, the salp swarm algorithm to minimize a cost function J; and
updating, by the 3DOF-FOPIDN controller of each power system, the set of gain parameters of the 3DOF-FOPIDN controller.

13. The method of claim 12, further comprising:
calculating the cost function J as an integral time absolute error given by:
$$J = ITAE = {\int }_{0}^{∞} t ( \vert Δ {f}_{1} \vert + \vert Δ {f}_{2} \vert + \vert Δ {P}_{tie} \vert ) dt ,$$
where t is time, Δf₁ is the frequency deviation value of the first power system and Δf₂ is the frequency deviation value of the second power system.

14. The method of claim 13, further comprising:
controlling, by the 3DOF-FOPIDN controller, a proportional gain Kₚ, an integral gain Kᵢ, and a derivative gain K_{d} of the set of gain parameters of each power system to be within a range of 0 to 15.

15. The method of claim 14, further comprising:
controlling, by the 3DOF-FOPIDN controller, a first control vector u of the set of gain parameters of each power system to be within a range of 0≤μ≤1.

16. The method of claim 15, further comprising:
controlling, by the 3DOF-FOPIDN controller, a second control vector λ of the set of gain parameters of each power system to be within a range of 0≤λ≤1.

17. The method of claim 16, further comprising:
controlling, by the 3DOF-FOPIDN controller, a filter factor N of the FOPIDN controller to be within a range of 1 to 300.

18. A hybrid controller configured to integrate interconnected power sources with renewable energy sources in a first power system located in a first geographic region and a second power system located in a second geographic region, wherein the first power system and the second power system are connected by an inter-area tie-line, comprising:
a three degrees of freedom fractional order proportional integral derivative (3DOF-FOPIDN) controller located in each power system, wherein the 3DOF-FOPIDN controller includes a receiver configured to receive an area control error (ACE) signal from the respective power system, an electrical circuitry, a memory having program instructions, wherein the program instructions include a salp swarm algorithm stored therein, and at least one processor configured to execute the salp swarm algorithm to update a set of gain parameters of the 3DOF-FOPIDN controller based on the ACE of each power system; and
a slave model predictive controller (MPC) operatively connected to the 3DOF-FOPIDN controller of each power system, wherein the slave MPC is configured to generate a set of droop error correction signals and transmit the droop error correction signals to renewable energy sources.

19. The hybrid controller of claim 18, further comprising:
a cost function J stored within the program instructions, wherein the processor of each power system is configured to execute the salp swarm algorithm to minimize the cost function J.

20. The hybrid controller of claim 19, wherein:
the set of gain parameters of each power system includes a proportional gain Kp, an integral gain Ki, and a derivative gain Kd, wherein each of the gain parameters is within a range of 0 to 15;
the set of gain parameters of each power system further includes a first control vector u and a second control vector λ, wherein 0≤μ≤1 and 0≤λ≤1;
a filter factor N of the 3DOF-FOPIDN controller of each power system is selected to be in a range of 1 to 300; and
the cost function J is an integral time absolute error given by:
$$J = ITAE = {\int }_{0}^{∞} t ( \vert Δ {f}_{1} \vert + \vert Δ {f}_{2} \vert + \vert Δ {P}_{tie} \vert ) dt ,$$
where t is time, Δf₁ is a frequency deviation value of the first power system and Δf₂ is a frequency deviation value of the second power system.
